(19) United States
(12) Patent Application Publication
(10) Pub. No.: US 2011/0151069 A1
(43) Pub. Date: Jun. 23, 2011

(54) Infant or baby feeding systems

(76) Inventor: Edward James Harding, Snerrisham (GB)

(21) Appl. No.: 12/311,450

(22) PCT Filed: Oct. 1, 2007
(86) PCT No.: PCT/GB2007/050601

§ 371 Date: Mar. 8, 2011

(30) Foreign Application Priority Data
Sep. 29, 2006 (GB) 0619202.5
Nov. 7, 2006 (GB) 0622147.7
Jan. 26, 2007 (GB) 0701502.7
May 16, 2007 (GB) 0709368.5
May 30, 2007 (GB) 0710238.7
Jun. 6, 2007 (GB) 0710818.6

(51) Int. Cl. B65D 85/72; B65D 41/00; B65D 41/32; B65D 25/40; B65D 35/02; B65D 30/08; B65D 85/00; H05B 3/02; A61J 11/04

(52) U.S. Cl. 426/117; 220/200; 220/265; 222/566; 222/92; 220/359.4; 383/109; 206/459.1; 219/386; 215/11.1

(57) ABSTRACT

An infant feeding system comprising a sterile sealed laminated bag having a predetermined quantity of liquid infant food sealed therein, a compressed integral sterile teat sealed with the bag closure and or spout and a protective cap for the teat, the system being arranged such that the cap can be removed to enable the infant to feed from the sterile teat and food.

### FIELD OF THE INVENTION

This invention relates to varied improvements to disposable non-reusable laminated fluid containers, and more particularly, but not by way of limitation, to a disposable non-reusable spouted bag which may be constructed through incorporating a disposable teat or through utilising a spouted bag which may allow a reusable teat to be attached.

### DISCUSSION

Baby bottles are well known in the art. Conventional baby bottles (also referred to herein as baby feeding systems or feeding systems) include a glass or plastic container having an externally threaded container opening, a bottle-feeding teat, and a screw-on top for securing the teat to the container. Both the container and the teat are reusable.

A standard teat, which is defined and refined herein to mean a feeding teat of the type commonly used with reusable baby bottles utilizing screw-on caps, is commonly made of either natural or synthetic rubber, both of which are flexible and compressible. Standard teats are available for premature babies, newborns, and toddlers. An opening in the tip end (also referred to as the mouth portion) of the teat permits fluid to be withdrawn from the container in response to a sucking action by the nursing baby. The size of the opening in the tip end of the teat (also referred to as the teat opening) varies. For a premature baby, the teat opening is typically a small pinhole. For older babies and toddlers, the teat opening is often in the form of a cross cut or “X” to permit the baby to receive more fluid in response to the sucking action.

Caregivers normally feed babies milk, formula, juices, and water from a baby bottle. In addition, some babies—especially older babies—receive dilute mixtures such as cereal-formula or thinned vegetables via baby bottle. As used herein, the term “fluid” or is used interchangeably to include all forms of nutrition capable of administration to babies through a teat. The reference to “spouted bags” may also be used to describe a “pouch” and or “sachet”.

Reusable baby bottles are major sources of concern for parents and other caregivers. Bottle prepares must properly clean and sterilize baby bottles, bottle feeding teats, and caps to prevent introduction of harmful contaminants into baby formula and other beverages to be consumed by the baby. The sterilization process is time consuming; moreover, the bottle prepare may fail to clean a reusable baby bottle thoroughly and thereby place the baby at risk.

Several prior disposable bottles and or feeding bags have been proposed due to the advantages they offer, though these methods have as yet not succeeded in combining the benefits of automated controlled warming, aseptic, anti colic, ready to go, no preparation, no washing, no sterilisation and or hassle free convenience advantages within one single affordable feeding systems, which is also efficient in its production and therefore affordable.

Preparation of the beverage also presents risks. Formula and juices frequently require dilution of a concentrate using water. A simple mistake in understanding directions or in the measurement of the ingredients of a baby beverage may subject the baby to gastric distress or nutritional imbalances. Although some contaminants and bacteria are not harmful to adults, babies are especially sensitive because their systems have not yet fully developed. Dilution water and ordinary tap water in particular, may contain trace amounts of minerals or bacteria, which are harmful to babies. Chlorination of drinking water, although common is not universal. Water systems in remote locations often lack the chlorine residual necessary to sanitize the water for drinking purposes. While the use of bottled water reduces the risk of contamination, bottle prepares may not seal the bottled water between uses.

Assuming the bottle preparer properly sterilizes bottle parts and correctly dilutes the concentrated baby beverage with suitable dilution water; reusable baby bottles present additional problems. The bottle preparer may incorrectly estimate the amount of formula a baby may need, resulting in wasted formula. Prepared baby bottles must be refrigerated prior to use, which in turn creates inconvenience and expense for transporting a baby bottle. Baby bottles also tend to leak through the teats when the baby bottles are subjected to mechanical forces, causing clothes and other objects to be stained or damaged by the leaking beverage.

### SUMMARY OF THE INVENTION

The present invention relates to a various improvements to baby bottles through utilising disposable non-reusable spouted bag, which serves as both shipping container and feeding system for ready-to-use fluids. The spout may be sealed with a foil and the foil pierced or removed by foil piercing teeth incorporated into a reusable teat base. The teat and teat base may be attached through utilising a thread or snap connection which locks the teat to the spout of the non-reusable spouted bag open end of the container whilst also piercing the foil. The spout may also be non-reusable and integral or co-injected to the spouted bag and may be contained or compressed within spouted and or spouted bag. The bag may also have an integral circuit or heater element, which allows the fluid within the bag to be heated simply through attaching a power source to terminals on the bag. The present invention eliminates cleaning and sterilizing of conventional baby bottle containers. The disposable non-reusable spouted bag also eliminates beverage preparation, warming and refrigeration of the filled baby bottle. When filled with premixed fluid, the disposable non-reusable spouted bag is ready to use when the nursing baby is ready to eat. Contents of the disposable non-reusable spouted bag can be controlled precisely at the factory. For example, the factory can purify water efficiently and economically on a large scale for mixing with baby nutrients. The spouted bag will also crush whilst the fluid or beverage is being consumed thus eliminating the vacuum which occurs in conventional baby feeding bottles, this crushing of the bag reduces the likelihood of the baby ingesting excess air and thus suffering from colic.

The disposable non-reusable spouted bag of the present invention is sealed to prevent spoilage, so refrigeration is unnecessary. Many baby beverages, including milk and orange juice, are perishable and may not be left unsealed at ambient temperatures because they become unfit for baby consumption.

Factory preparation of the formula permits date stamping of the disposable non-reusable spouted bag (and its contents), thereby providing valuable information to parents and caregivers regarding the sealed contents of the disposable non-reusable spouted bag.

The main object of the invention is to provide packaging system which eliminates the hassle and or preparation processes required for formula and powder bottle feeds, i.e. washing, sterilising, measuring, warming and colic, by providing an aseptic, ready to go, cheap and user friendly feeding system which may be produced efficiently.

One object of the present invention is to provide a disposable non-reusable spouted bag suitable for pre-filling with ready-to-use baby beverages.

Another object of the present invention is to provide a disposable non-reusable spouted bag, which eliminates preparation of the baby beverage at the point of use and subsequent warming of the beverage.

Another object of the present invention is to minimize the risk of contamination of baby beverages.

Still another object of the present invention is to provide a disposable non-reusable spouted bag, which is factory-sealed and leak-resistant.

A still further object of the present invention is to provide a feeding system, which ensures proper proportioning of water and nutrients in baby beverages.

Yet another object of the invention is to maximize formula usage efficiency by preventing the bottle preparer from overestimating the amount of formula to be prepared for the nursing baby.

Another object of the invention is to provide a bottle-feeding system, which will indicate tampering.

Another object of the invention is to provide a bottle-feeding system, which utilises the minimum amount of packaging.

Still another object of the present invention is to provide a disposable non-reusable spouted bag which collapses as the fluid is consumed by the baby and thus eliminating a vacuum being created within the bag thus reducing the risk of the baby getting colic.

Other objects, features, and advantages of the present invention will become clear from the following description of the preferred embodiment when read in conjunction with the accompanying drawings and claims.

### BRIEF DESCRIPTION OF THE DRAWINGS

FIG. 1 is a perspective view of a reusable teat and a disposable non-reusable spouted bag of the present invention showing a spout with an unopened foil.

FIG. 2 is a perspective view of a reusable teat and a disposable non-reusable spouted bag and flexible bag sleeve of a present invention showing an unopened foil.

FIG. 3 is a perspective view of a reusable teat and a disposable non-reusable spouted bag and ridged bag sleeve of the present invention showing an unopened foil.

FIG. 4 is a perspective view of a reusable teat and a disposable non-reusable spouted bag and ridged bag sleeve of the present invention showing the teat in a ready-to-use position.

FIG. 5 is a cross sectional front view of a reusable teat and a disposable non-reusable spouted bag contained within ridged bag sleeve of the present invention showing the teat in a ready-to-use position.

FIG. 6 is a cross sectional perspective view of a reusable teat and a disposable non-reusable spouted bag and an outer cylinder or canister of the present invention showing an unopened foil.

FIG. 7 is a cross sectional front view of a reusable teat and a disposable non-reusable spouted bag and an outer cylinder or canister of the present invention showing an unopened foil.

FIG. 8 is a cross sectional perspective view of a reusable teat and a disposable non-reusable spouted bag and an outer cylinder or canister of the present invention showing an unopened foil.

FIG. 9 is a cross sectional perspective view of a reusable teat and a disposable non-reusable spouted bag and an outer cylinder or canister of the present invention showing the teat in a ready-to-use position.

FIG. 10 is a cross sectional perspective view of a reusable teat and a disposable non-reusable spouted bag and an outer cylinder or canister of the present invention.

FIG. 11 is a cross sectional front view of a reusable teat and a disposable non-reusable spouted bag and an outer cylinder or canister of the present invention showing the teat in a ready-to-use position.

FIG. 12 is a cross sectional side view of a reusable teat and reusable bottle casing and a non-reusable spouted bag of the present invention showing an unopened foil.

FIG. 13 is a cross sectional side view of a reusable teat and reusable bottle casing and a non-reusable spouted bag of the present invention showing an unopened foil.

FIG. 14 is a cross sectional side view of a reusable teat and reusable bottle casing and a non-reusable spouted bag of the present invention showing the teat in a ready-to-use position.

FIG. 15 is a perspective cross sectional front view of a non-reusable teat and a disposable non-reusable spouted bag of the present invention showing the teat in a ready-to-use position with the protective cap still attached.

FIG. 16 is a side cross sectional view of a reusable teat and a side view of a disposable non-reusable spouted bag of the present invention showing the teat in a ready-to-use position.

FIG. 17 is a perspective semi cross sectional view of a non-reusable teat and a disposable non-reusable spouted bag of the present invention showing the teat in a ready-to-use position with the protective cap still attached.

FIG. 18 is a perspective part cut out sectional view of a non-reusable teat and a disposable non-reusable spouted bag of the present invention showing the teat in a ready-to-use position with the protective cap still attached.

FIG. 19 is a cross sectional perspective view of a non-reusable teat and a disposable non-reusable spouted bag of the present invention showing the teat contained within the spout and an unopened foil.

FIG. 20 is a perspective view of a non-reusable teat and a disposable non-reusable spouted bag of the present invention showing the teat in a ready-to-use position.

FIG. 21 is a cross sectional perspective view of bag charging stand containing disposable non-reusable spouted bag of the present invention showing the teat contained within the spout and an unopened foil.

FIG. 22 is a cross sectional view of bag heating socket containing disposable non-reusable spouted bag of the present invention with removable handles and showing the teat contained within the spout and an unopened foil.

FIG. 23 is a cross perspective view of a disposable non-reusable spouted bag of the present invention with removable handles and showing the teat in a ready-to-use position.

FIG. 24 is a cross sectional front view of a disposable non-reusable spouted bag showing a spout with an unopened foil.

FIG. 25 is a cross sectional front view of a disposable non-reusable spouted bag showing a spout with an unopened foil.

FIG. 26 is a semi cross sectional perspective view of disposable non-reusable spouted bag of the present invention showing the spout sealed with an unopened foil.

FIG. 27 is a semi cross sectional perspective view of disposable non-reusable spouted bag of the present invention showing the spout sealed with an unopened foil.

FIG. 28 is a cross sectional perspective view of bag charging stand containing disposable non-reusable spouted bag of the present invention and showing the teat contained within the spout and an unopened foil.

FIG. 29 is a cross sectional perspective view of a charging stand containing a disposable non-reusable spouted bag and showing a flexible resistor.

FIG. 30 is a semi cross sectional perspective view of disposable non-reusable spouted bag with a breast pump attached.

FIG. 31 shows three cross sectional views of a pouch or bag or sachet closure with an integral compressible teat.

FIG. 32 shows two semi cross sectional perspective views of a pouch or bag with compressible teat closure.

FIG. 33 shows three cross sectional views of a pouch or bag or sachet closure with a compressible teat.

FIG. 34 shows two cross sectional perspective views of a pouch or bag with compressible teat closure.

FIG. 35 shows three cross sectional views of a pouch or bag or sachet closure with an extended spout and a compressible teat.

FIG. 36 is a semi cross sectional perspective view of a pouch or bag or sachet and closure with semi ridged pressurised gas pockets.

FIG. 37 is a cross sectional view of a pouch or bag or sachet with semi ridged pressurised gas pockets.

FIG. 38 is a semi cross sectional perspective view of a pouch or bag or sachet for feeding nursing animals which said pouch includes semi ridged pressurised gas pockets.

FIG. 39 shows two cross sectional views of a narrow teat closure and or spout which includes flexible mouth guards.

FIG. 40 shows a semi cross sectional views of a pouch or bag or sachet which extends as to form a foil or film covering or lid for the closure or teat and or spout.

FIG. 41 shows a semi cross sectional views of a pouch or bag or sachet with the foil and or film covering or lid being removed from the closure or teat and or spout.

FIG. 42 shows three example cross sections of a bag with semi pressurised gas pockets and a frontal plan view example of a bag with multiple low pressure and high pressure gas pockets.

### DETAILED DESCRIPTION OF THE INVENTION

In the following description of the invention, like numerals and characters designate like elements throughout the figures of the drawings.

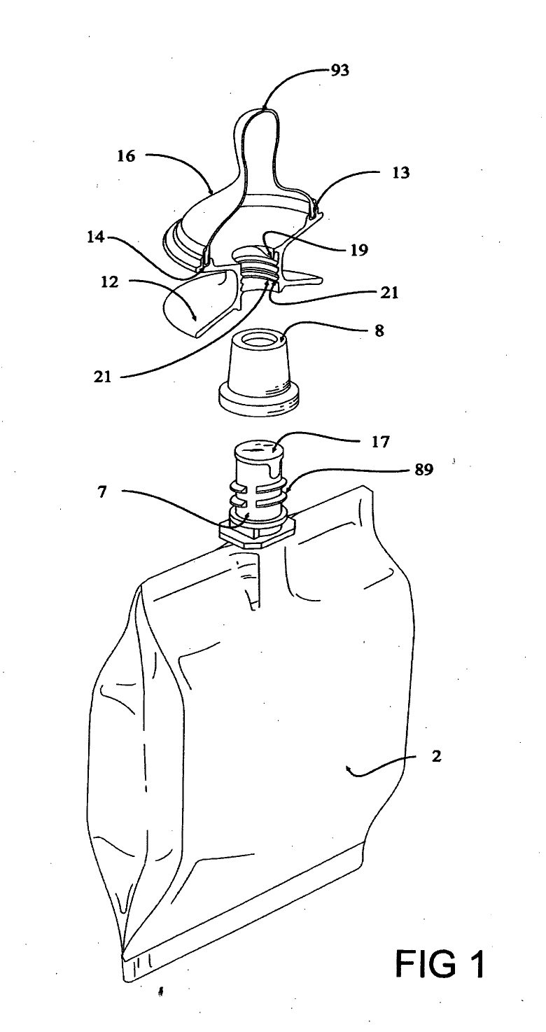

FIG. 1 is a perspective view of a reusable teat 16 and a disposable non-reusable spouted bag 2. The teat base may incorporate foil piercing teeth 19 which will pierce the foil 17 as the teat base thread 21 is threaded to thread 89 on the bag spout 7. The bag spout 7 may also have the foil 17 removed manually through incorporating a flap or pull-tab. The bag spout 7 may include a removable cap 8 which protects the bag spout 7 from contamination. The teat 16 may be removed from the teat base as the teat may include a plastic clip or threaded rim 13 at its base which may mesh, thread, clip or attach to the teat base rim recess 14 allowing the teat 16 and teat base 12 to be dissembled for the purpose of cleaning etc. The spouted bag 2 may take many forms and be folded or created using a variety of manufacturing methods.

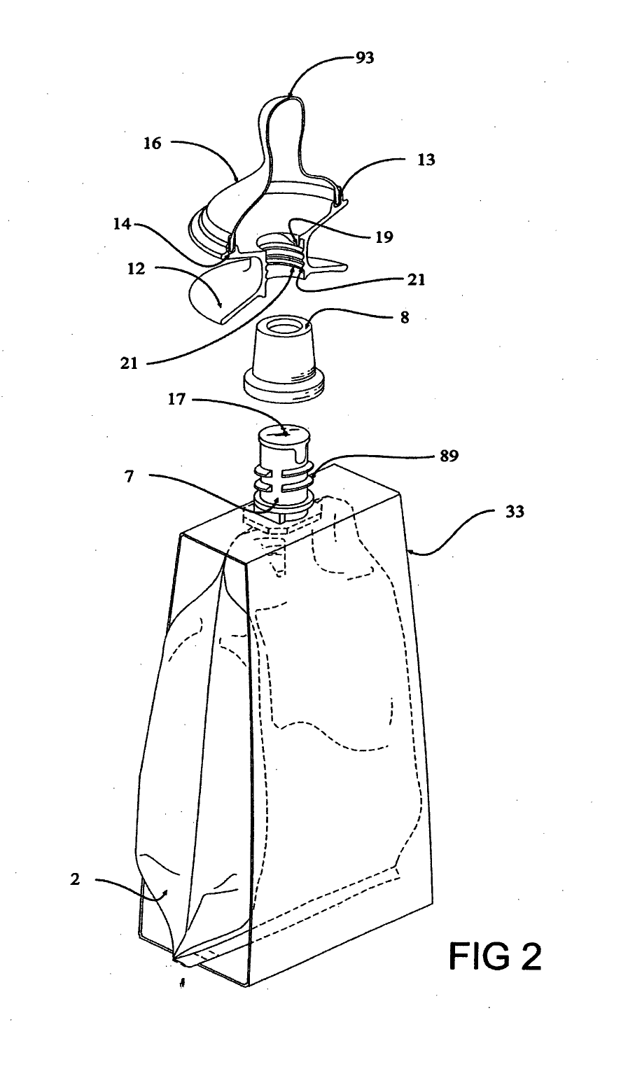

FIG. 2 is a perspective view of a reusable teat 16 and a disposable non-reusable spouted bag 2 as described in FIG. 1. The spouted bag 2 may be enclosed or partly enclosed by a disposable outer casing 33 which may be card or another folded material being specifically designed and or folded to making a form which is easy to hold for feeder or baby whist supporting and protecting the spouted bag 2.

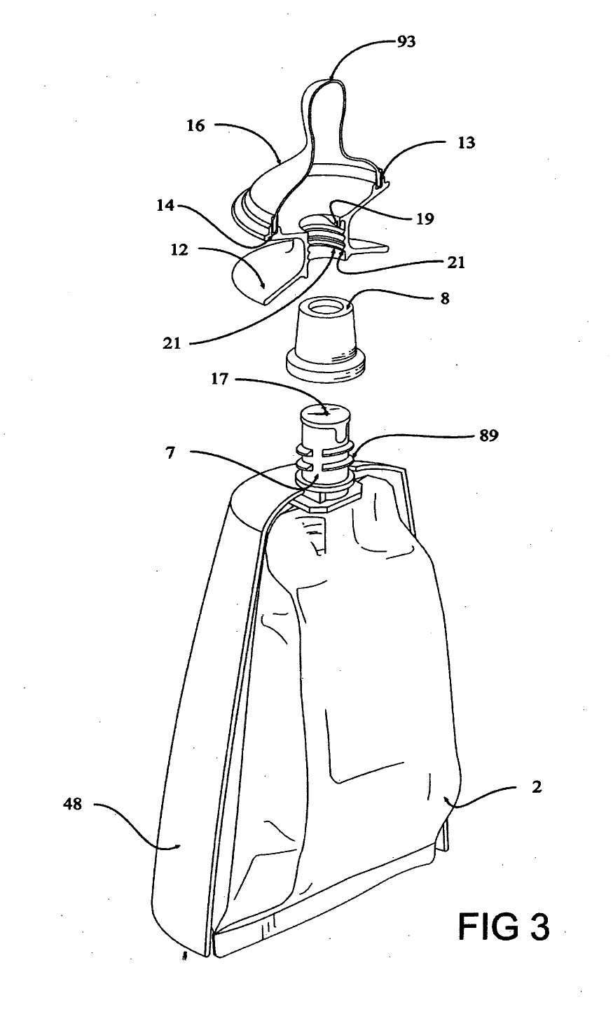

FIG. 3 is a perspective view of a reusable teat 16 and a disposable non-reusable spouted bag 2 as described in FIG. 1, 2. The spouted bag 2 may be enclosed or partly enclosed by a reusable outer casing 48 which may be plastic and or rubber or another material being suitable to create an outer casing 48 being of easy to hold for feeder and or baby whist supporting and protecting the spouted bag 2. The outer casing 48 shown in FIG. 3 is a cross sectional perspective view and designed with an open base as to allow the spouted bag to be inserted from the underside of the outer casing 48.

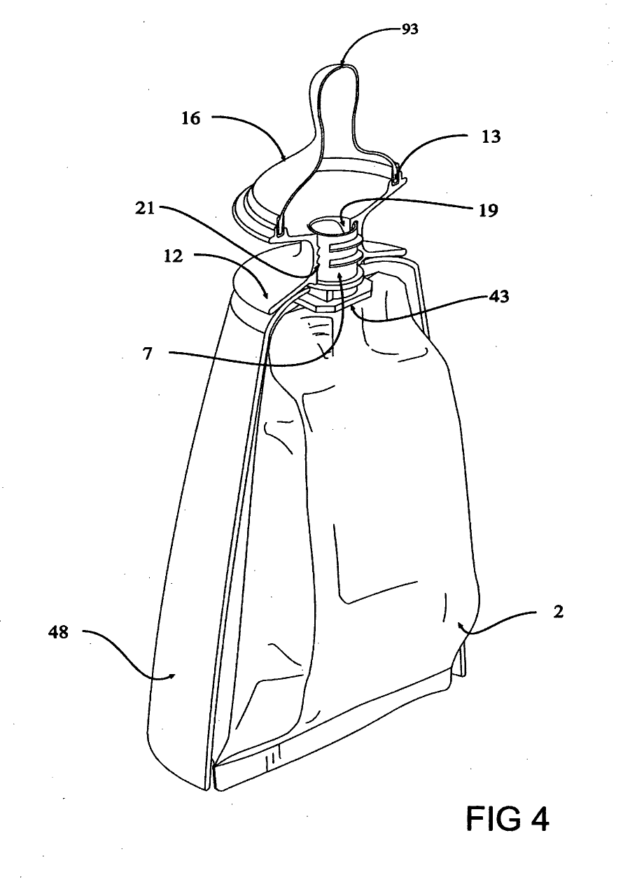

FIG. 4 is a perspective view of a reusable teat 16 and a disposable non-reusable spouted bag 2 as described in FIG. 1, 2, 3. The bag spout foil 17 has been pierced by the foil piercing teeth 19 which allow the fluid 1 contained within the spouted bag 2 to flow into the teat 16. As the teat base thread 21 is threaded to spout thread 89 on the bag spout 7 the bag spout 7 is pulled tight against inside of the casing 48 onto which it may key and lock utilising the spout flanges 43 as the teat base 12 also pulls tight onto the top of the casing 48.

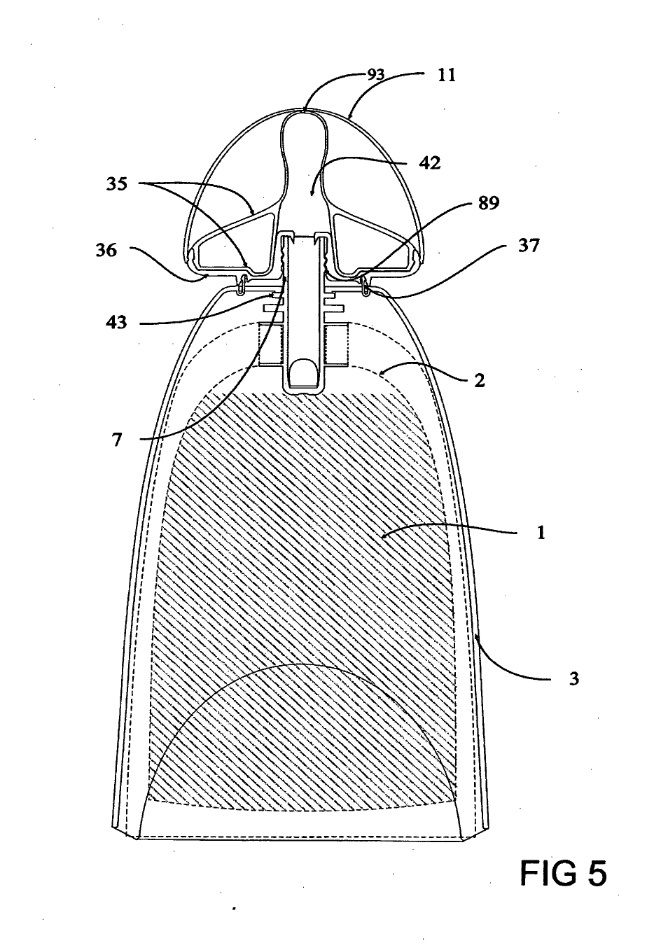

FIG. 5 is a cross sectional front view of a reusable partitioned teat 35 and a disposable non-reusable spouted bag 2. The spouted bag 2 may be enclosed or partly enclosed by a reusable outer casing 57. The outer casing 57 shown in FIG. 5 is designed with an open base as to allow the spouted bag to be inserted from the underside of the outer casing 57. The outer casing 57 may be designed to clip or attach to the partitioned teat base 36 after which the reusable partitioned teat 35 and teat base 36 may rotate whilst keyed into the casing 57. The teat base thread 21 is threaded to the spout thread 89 and the bag spout 7 is pulled tight against inside of the casing 57 onto which it may key and lock as the teat base 36 also pulls tight onto the top of the casing 57. The partitioned teat 35 is designed to restrict the flow of fluid to a central channel 42.

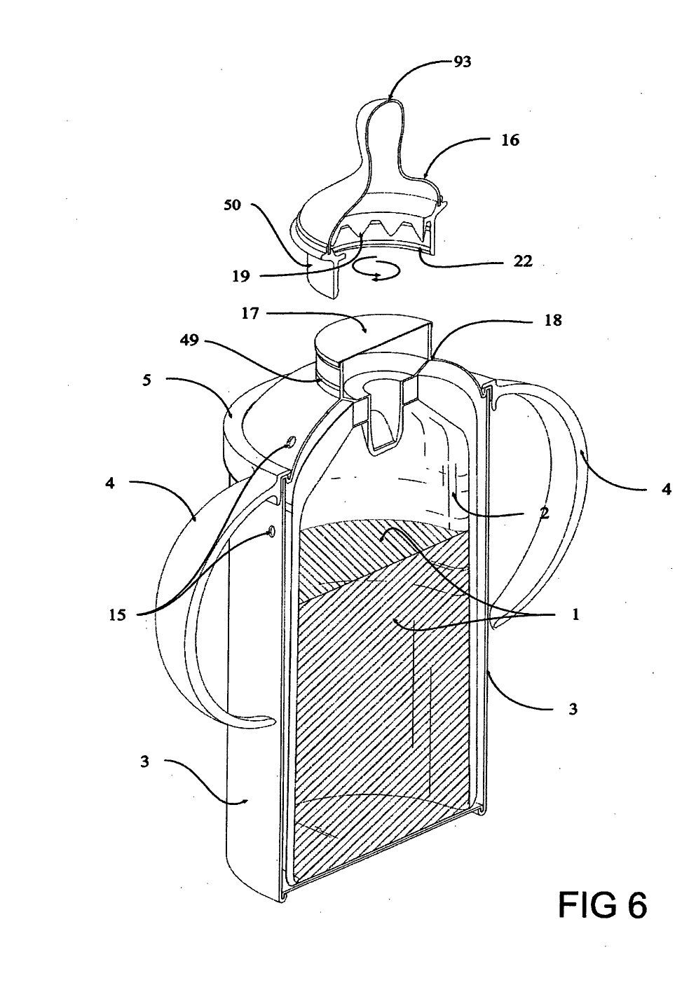

FIG. 6 is a perspective view of a reusable teat 16 and a disposable non-reusable spouted bag 2 and non-reusable canister 3. The non-reusable canister may be constructed of card and or plastic and may include air holes 15 or perforations which allow air to pass into the non-reusable canister 3 stopping a vacuum forming within the non-reusable canister 3 whilst the baby is feeding and the spouted bag 2 walls retract. The spouted bag 2 may include a capping spout 18 which is moulded or bonded to the spouted bag 2 and provides a capping for the non-reusable canister 3. This capping spout 18 may take many forms for example domed or flat and include spout ridges 49 or a spout thread 89 which allow the clip ridges 22 on the reusable teat 16 and or teat base to thread or push snap onto the bag spout. The non-reusable canister 3 may allow for a reusable handle 4 to be attached threaded or clipped on.

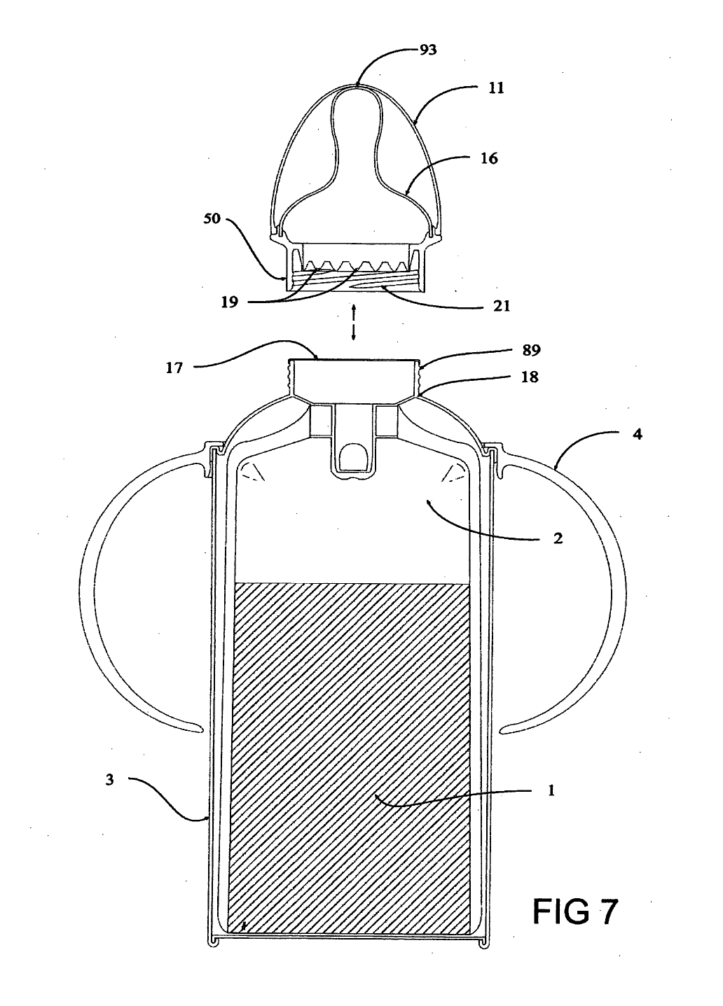

FIG. 7 is a cross sectional front view of a reusable teat 16 and a disposable non-reusable spouted bag 2 and non-reusable canister 3 as described in FIG. 6. The teat base 50 and bag spout 18 may include a thread 59 and 21.

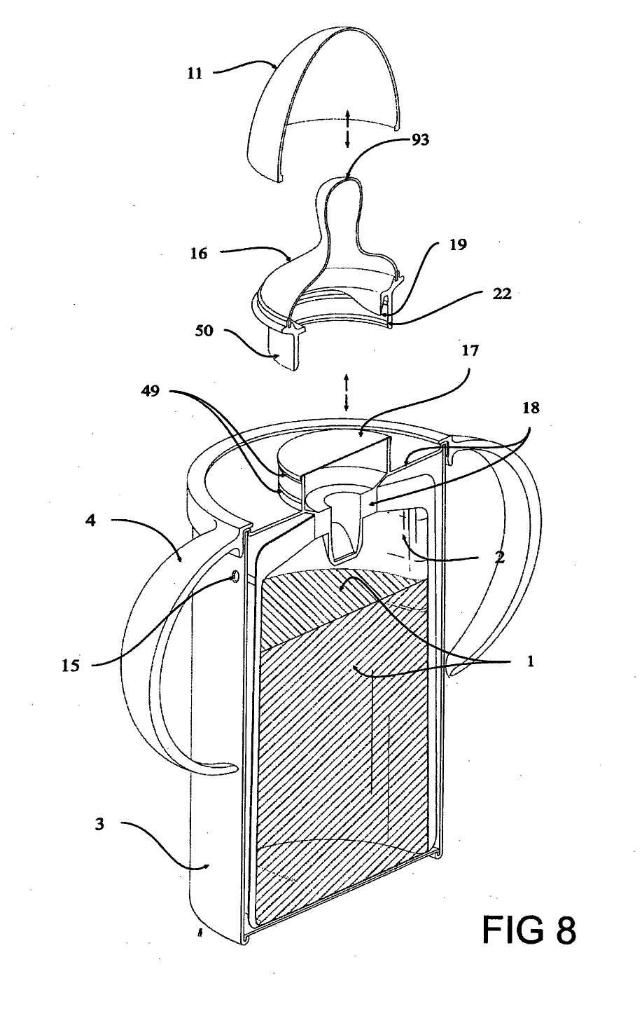

FIG. 8 is a cross sectional perspective view of a reusable teat 16 and a disposable non-reusable spouted bag 2 and non-reusable canister 3 as described in FIG. 6, 7. The teat base 50 shows another variation on possible foil piercing teeth 19 and a capping spout 18.

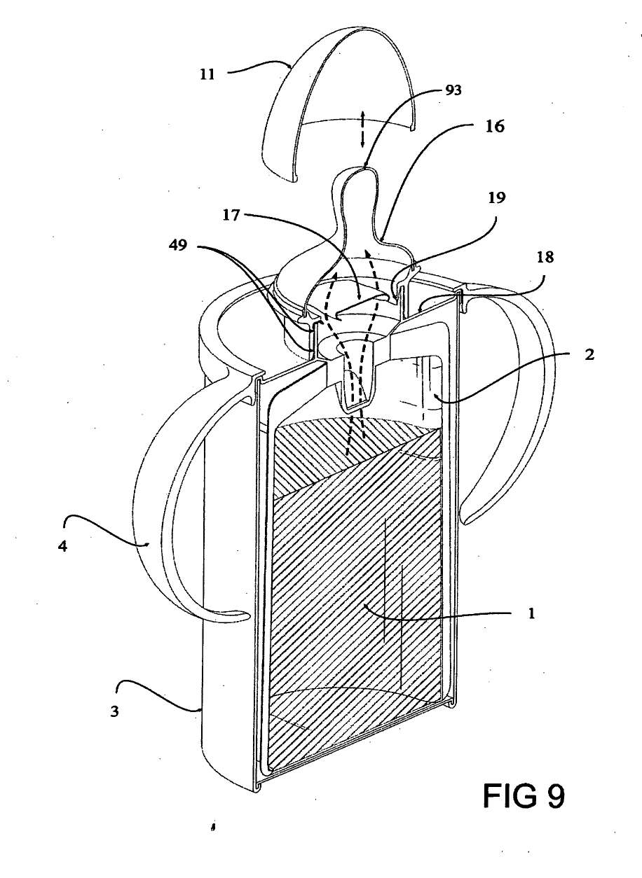

FIG. 9 is a cross sectional perspective view of a reusable teat 16 and a disposable non-reusable spouted bag 2 and non-reusable canister 3 as described in FIG. 6, 7. The dashed arrows show the route to which the fluid 1 may flow when the foil 17 has been pierced or broken by the teeth 19.

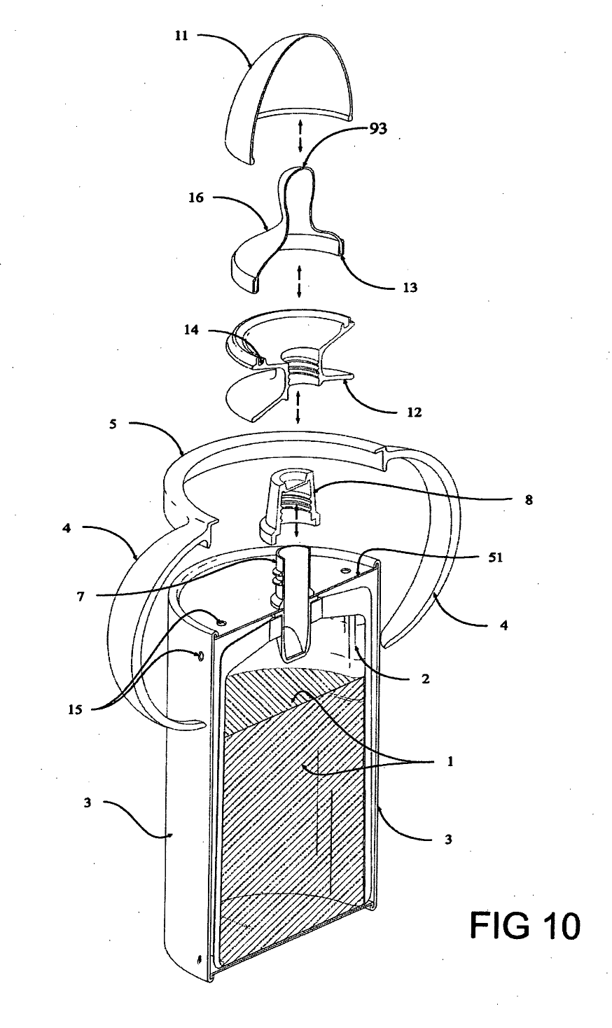

FIG. 10 is a cross sectional perspective showing a further example of a reusable teat 16 and reusable teat base 12 with a disposable non-reusable spouted bag 2 and non-reusable canister 3. The bag spout 7 may pass through the canister cap 51 the bag spout 7 may be bonded or keyed to this capping 51 in order to stop the spout 7 and spouted bag 2 rotating when the teat 16 and teat base 12 is attached.

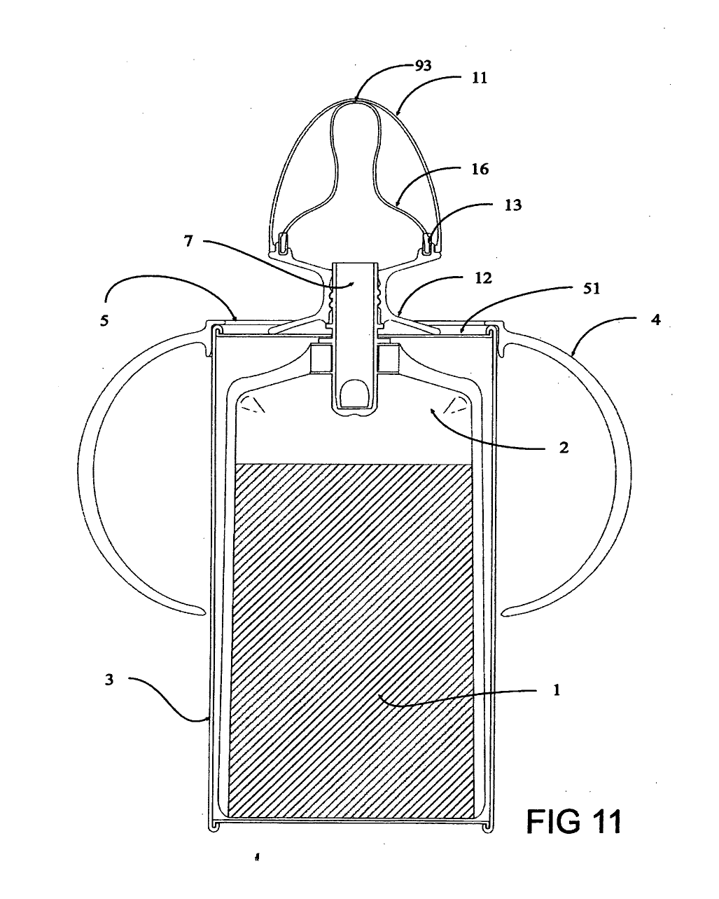

FIG. 11 is a cross sectional front view showing an assembled reusable teat 16 and reusable teat base 12 with a disposable non-reusable spouted bag 2 and non-reusable canister 3 as described in FIG. 10.

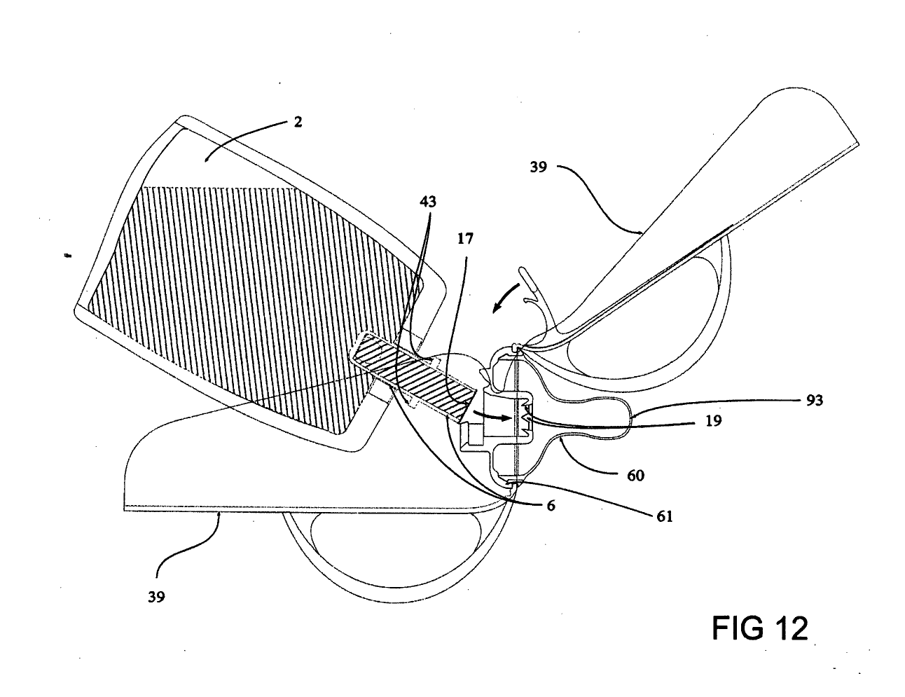

FIG. 12 is a cross sectional side view of a reusable teat 60 and reusable teat base 61 and a flexible spouted bag casing 39. The flexible spouted casing 39 is shown to be open may be designed with a split which allows the flexible spouted bag casing 39 to fold back on itself in an open locked position as shown for the insertion or removal or a spouted bag 2.

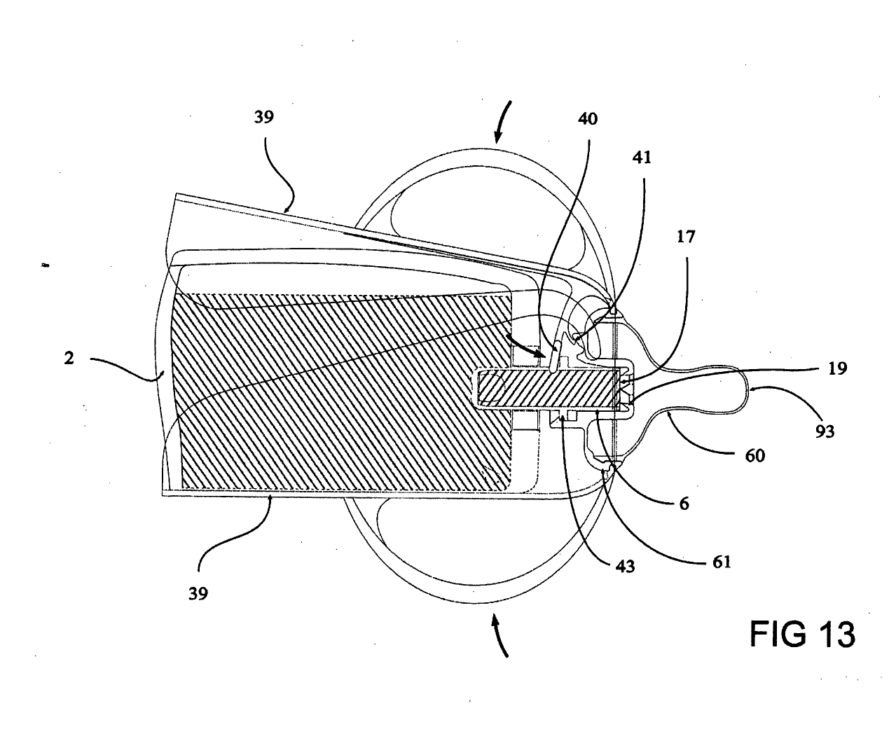

FIG. 13 is a cross sectional side view of a reusable teat 60 and reusable teat base 61 and a flexible spouted bag casing 39 as described in FIG. 12. The flexible spouted casing 39 is shown to be partly closed with a non-reusable spouted bag 2 inserted into the flexible spouted bag casing 39 and the spout 6 inserted into the re-usable teat base 61.

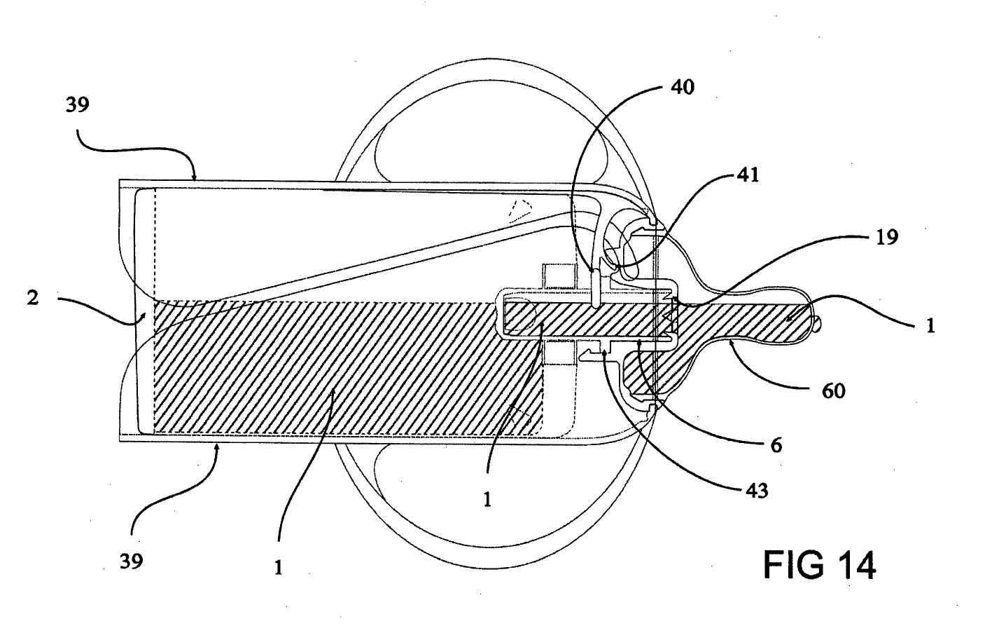

FIG. 14 is a cross sectional side view of a reusable teat 60 and reusable teat base 61 and a flexible spouted bag casing 39 as described in FIG. 12, 13. The flexible spouted casing 39 is shown to be in the closed position with a non-reusable spouted bag 2 inserted into the flexible spouted bag casing 39 and the spout 6 is inserted into the re-usable teat base 61 and pushed fully forward. The flexible spouted bag casing 39 has been closed and the lever arm 40 connected with the spout 6 which forced the spout 6 into the reusable teat base 61. With the flexible spouted bag casing 39 in its fully closed locked position the spout foil 17 has been pierced or broken open by the foil piercing teeth 19 and the fluid 1 may flow from the bag 2 into the reusable teat 60 and is ready for consumption. The lever arm 40 may include a hook or lever arm lock 41 which connects and locks with the reusable teat base 61 until such time as sufficient force is applied to snap open the lever arm lock 41 and thus open the flexible spouted bag casing 39 to remove or insert another sealed spouted bag 2. The teat 60 may be separated from the reusable teat base 61 and the reusable teat base 61 may be removed from the flexible spouted bag casing 39 allowing either or all components to be cleaned and or interchanged.

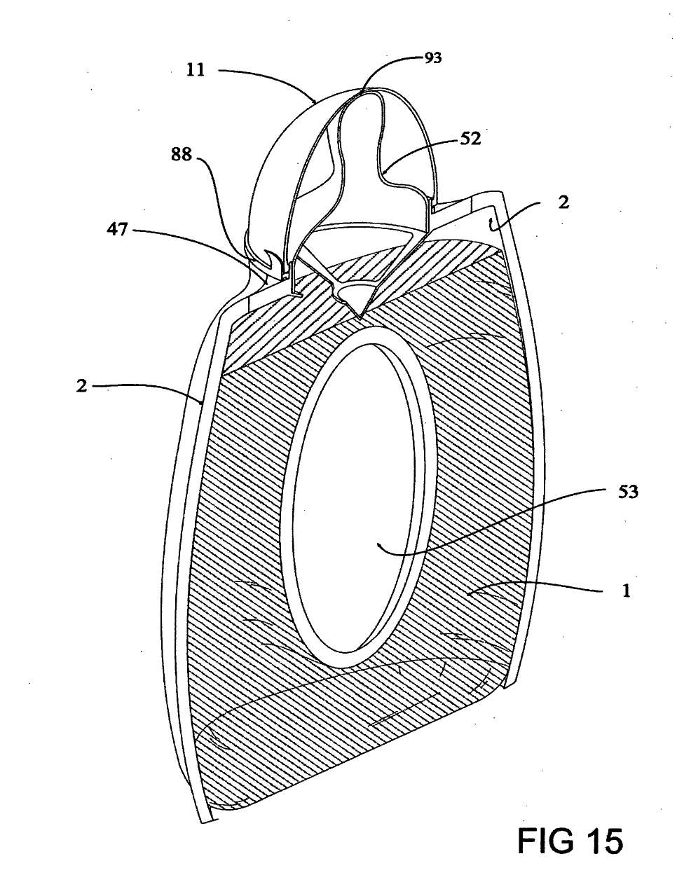

FIG. 15 is a cross sectional perspective view showing a non-reusable teat 52 and a non-reusable spouted bag 2. The bag bonded spout flange 47 is shown to provide a ridged or semi ridged opening for the bag 2 and also serving to bond the teat 45 to the bag 2. The non-reusable spouted bag 2 shows a hole or opening 53 which may allow the feeder or baby to easily grasp or hold the bag.

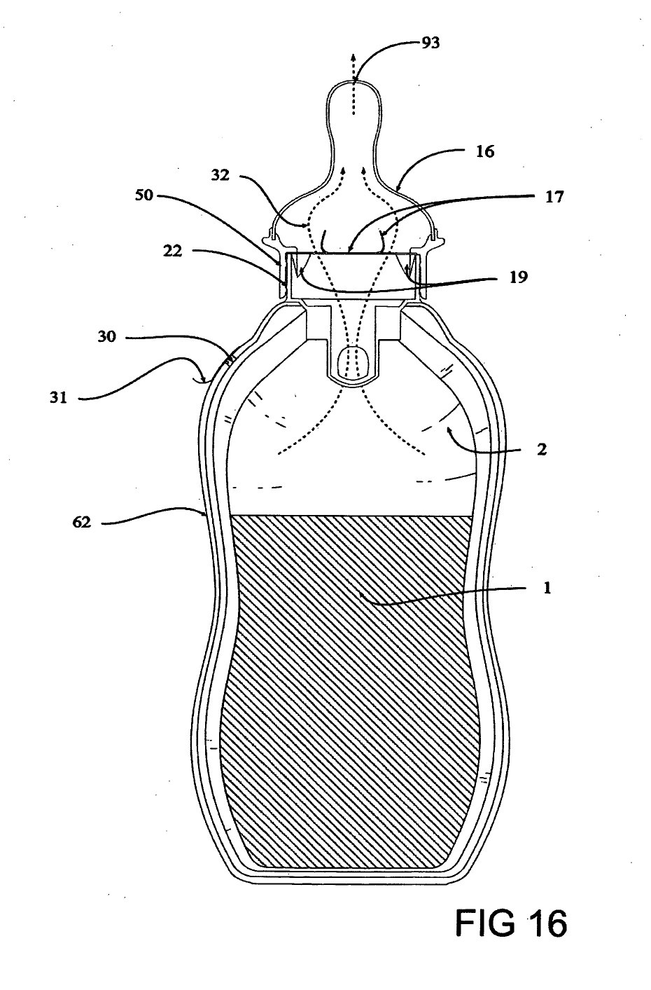

FIG. 16 is a cross sectional front view showing a reusable teat 16 and a non-reusable spouted bag bottle 62. The non-reusable spouted bag bottle 62 contains a non-reusable spouted bag 2 of which the spout 17 may be inserted and bonded to the bottle opening in manufacture. The non-reusable spouted bag bottle 62 may incorporate air holes or perforations 30 which may be closed by a removable sealing film or foil 31 and opened when the sealing film 31 is removed allowing air to pass into the non-reusable spouted bag bottle 62 and thus stopping a vacuum forming when the fluid is consumed from the reusable spouted bag 2.

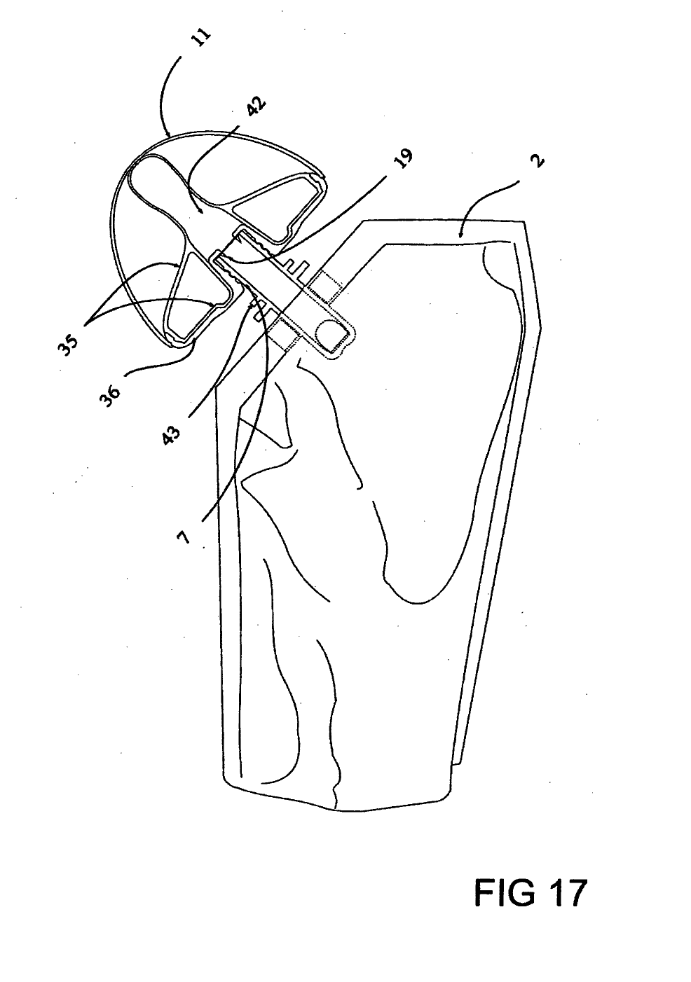

FIG. 17 is a cross sectional view of a reusable partitioned teat 35 and reusable teat base 36 attached to a further example of a disposable non-reusable spouted bag 2 of which the spout 7 is positioned over to one side of the centre of the spouted bag 2.

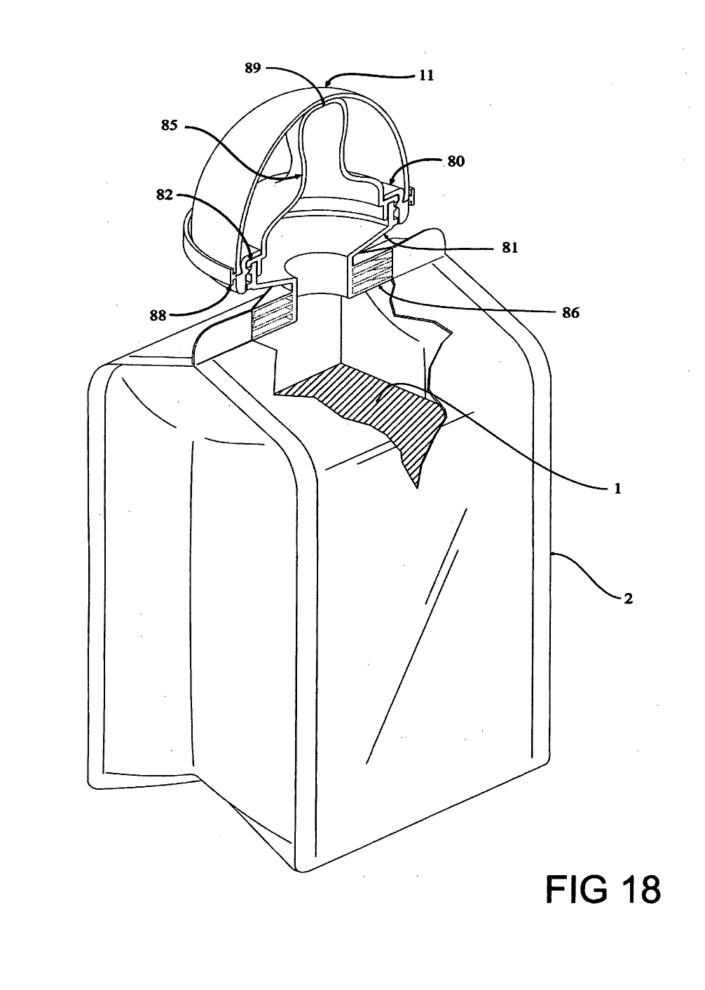

FIG. 18 is a cross sectional perspective view showing a further example of a non-reusable teat 85 and a non-reusable spouted bag 2. The non-reusable flexible teat 85, 82 may act as a water tight sealing gasket between rim 80 and bag spout 81 when rim 80 is threaded or bonded and or attached to bag spout 81. The teat cap 11 is shown to be connected to the rim 80 by means of a removable tamper strip 88 which may be torn off before removing the teat cap 11. The teat cap 11 may also apply pressure or be connected and or bonded to the peak of the teat as to seal the nipple hole 93 and stop the fluid 1 from leaking out of the nipple hole 93 until such point the teat cap 11 is removed. The bag spout 81 may be bonded to the bag 2 through utilising the veined spout base 86 being designed to provide the bag with a surface ideal for bonding into the bag opening when manufactured.

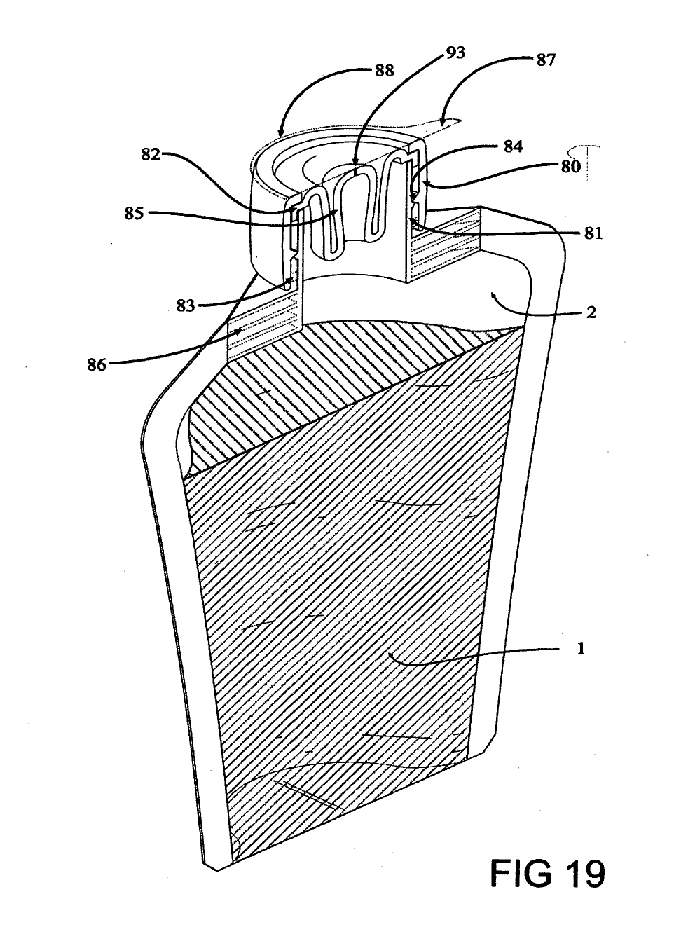

FIG. 19 is a cross sectional perspective view showing a non-reusable compressed teat 85 and a non-reusable spouted bag 2. The spout 81 contains the inverted non-reusable teat 85 which may be sealed into the spout 81 by means of a removable seal 88 and or foil. The removable seal 88 may be bonded to top of the spout capping rim 80 and bonded to the tip of the teat as to seal the nipple hole 93 and stop the fluid 1 from leaking out of the nipple hole 93 until the removable seal 88 is removed. The action of removing the seal 88 through pulling the tab 87 may also allow the teat 85 to be pulled out from its compressed position and allow it to stand upright protruding from the rim 80 into the upright ready to go position.

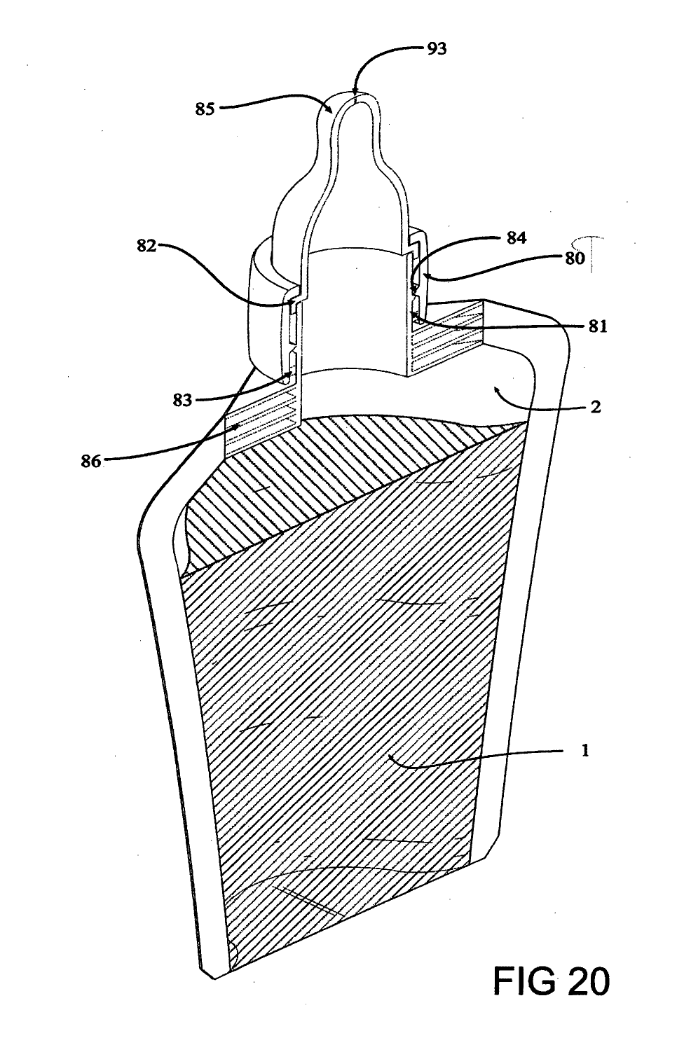

FIG. 20 is a cross sectional perspective view of the spouted bag as described in FIG. 19 with the removable seal 88 removed and the teat 85 in its upright ready to go position.

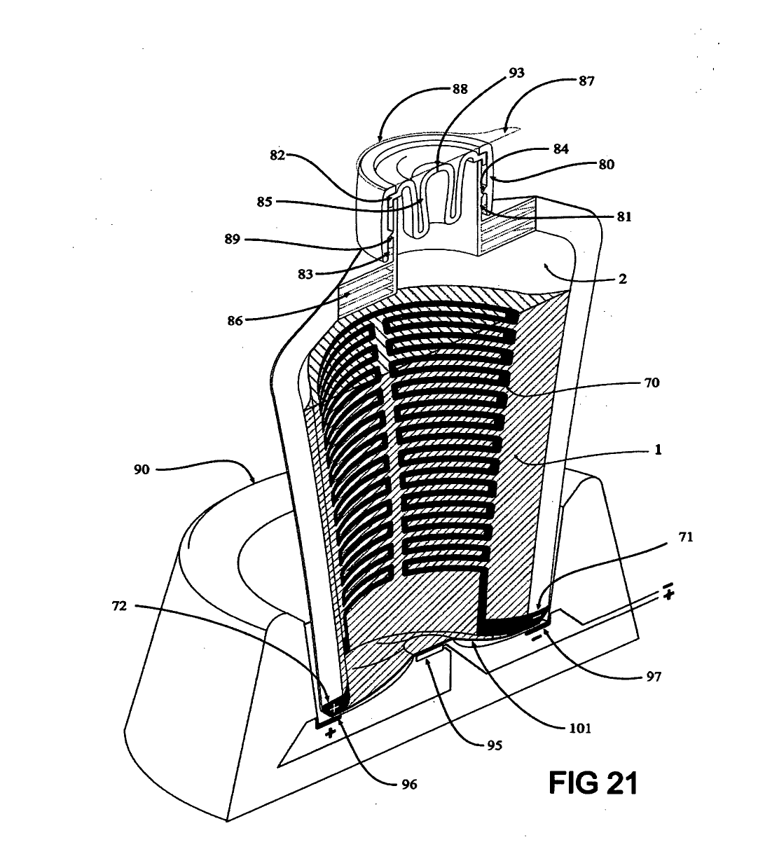

FIG. 21 is a cross sectional perspective view of a charging stand 90 containing a disposable non-reusable spouted bag as described in FIG. 19, 20. The bag 2 shows a flexible resistor 70 which may be contained within the bag 2 and or bonded or printed or etched directly onto the internal or external surface of the bag 2. The flexible resistor 70 will heat up when an electrical current is passed through it and warm or heat the fluid 1 contained within the bag 2. The flexible resistor 70 may obtain the required current through contacting or clipping the externally exposed positive 72 and negative 71 resistor terminals to the required power source terminals 96, 97 which may be charged from a transformer or a battery or a charging stand 90. The bag terminals 71, 72 may be located in any surface or position of the bag 2 or spout 81 the location being determined from the ease of manufacture and or ergonomics of the product. The teat 85 is shown to be contained within the spout 81 and covered with a removable seal 88. The teat 85 may be configured to automatically pop out into the ready to go position when the temperature of the fluid 1 has reached a specified amount due to the expansion of the air and or fluid 1 within the bag 2 thus causing the pressure within the bag 2 to rise and pushing the teat 85 out from the spout 81 into the ready to go position. A thermal protector switch 95 may be incorporated into the electrical circuit being located to contact or be close to the bag 2 allowing the thermal protector switch 95 to monitor the fluid 1 temperature and break the electrical circuit when the temperature of the fluid 1 in the bag 2 reaches a specified amount stopping the flexible resistor 70 from over heating the fluid 1 within the spouted bag 2.

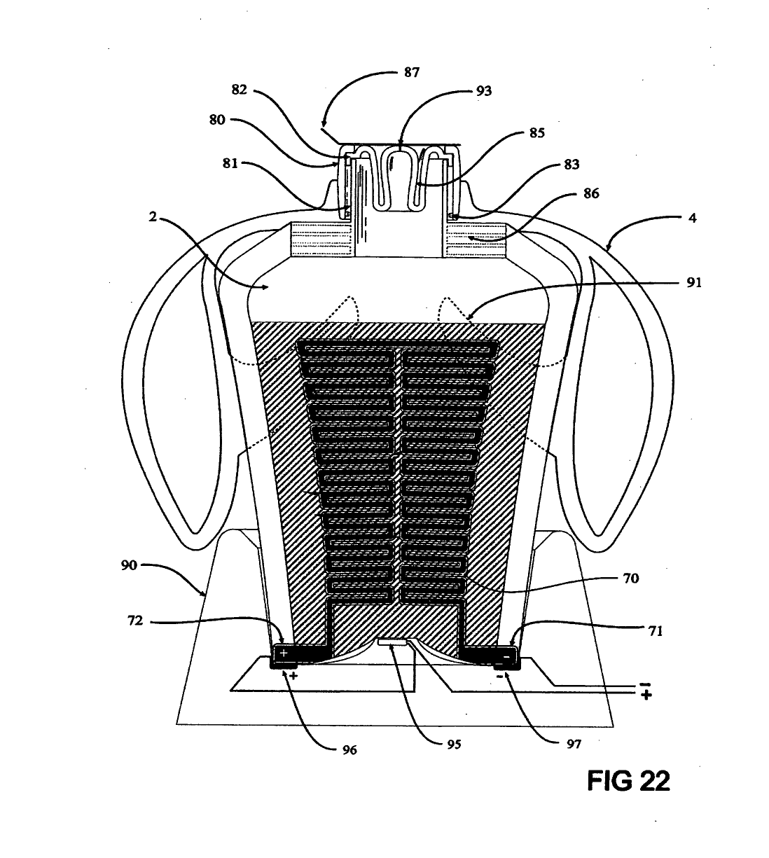

FIG. 22 is a cross sectional view of a charging stand 90 containing a disposable non-reusable spouted bag 2 as described in FIG. 21 with removable re-usable handles 4 which may clip or connect to the spout capping rim 80 and or bag 2 or spout 81 or bag spout flange 86. The removable handles 4 may include guidance arms 91 which serve to stop the flexible bag 2 from flopping around when handled. The spout capping rim 80 may include a thread 84 formed to accept the spout thread 89 and thus thread to the spout 81 in manufacture utilising the flexible teat 85, 82 as a gasket to create and air and fluid tight seal between the spout 81 and the spout capping rim 80. The spout 81 and or spout capping rim 80 may incorporate a one directional toothed ratchet locking system 83 which stops the spout 81 and the spout capping rim 80 from unlocking and or coming lose after being adjoined in manufacture.

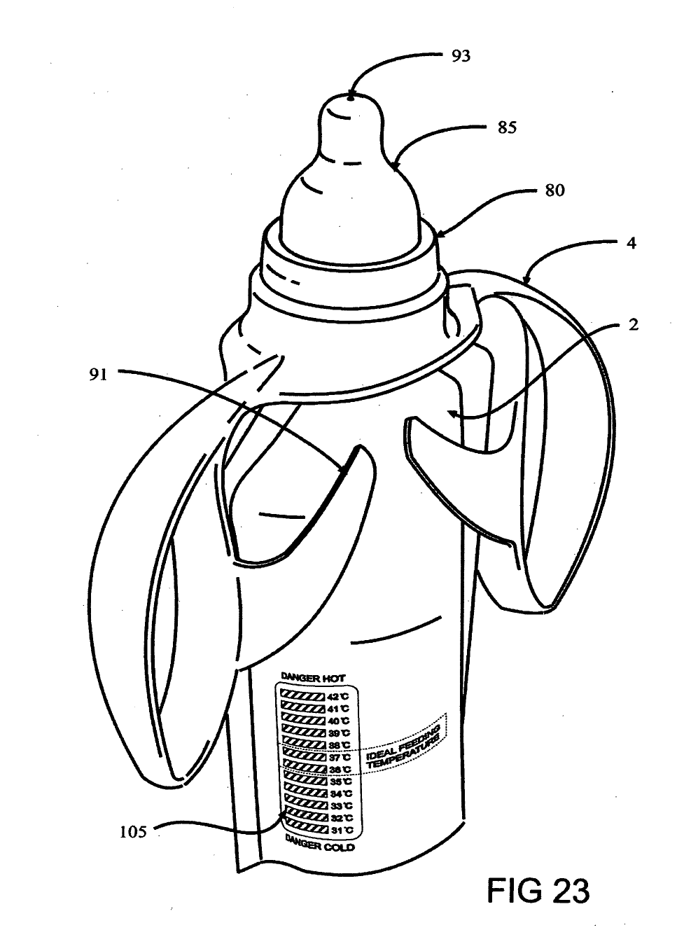

FIG. 23 is a perspective view of a spouted bag 2 with removable re-usable handles 4 which include guidance arms 91. The teat 85 is exposed and in the ready to go position.

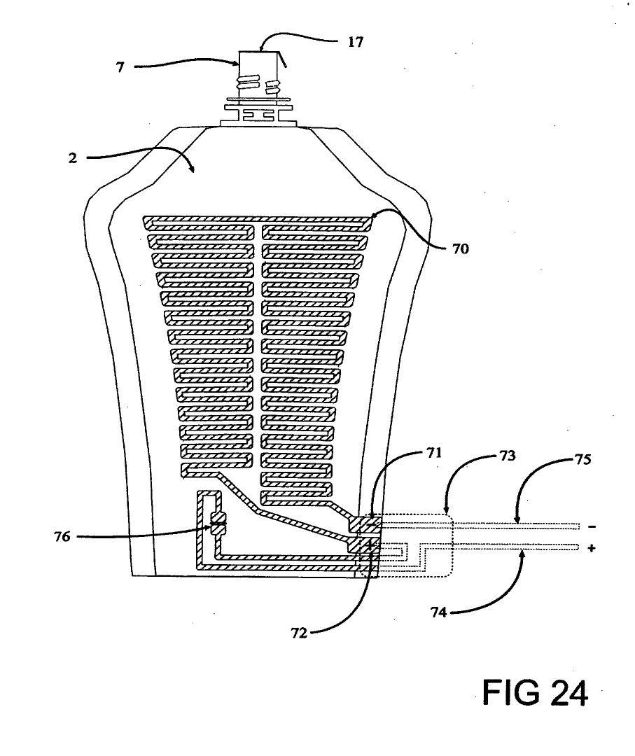

FIG. 24 shows a front view of a spouted bag 2 and demonstrates a further example of a flexible resistor 70. The bag 2 may incorporate more than one circuit on one or both sides or undersides of the bags 2 surface. A thermal protector switch or thermocouple 76 may be included in a separate circuit to the flexible resistor circuit thus allowing the thermal protector switch or thermocouple 76 to work independently without being affected directly by the flexible resistor in measuring the fluids 1 temperature and breaking or completing the circuit to heat the fluid 1 to a specified temperature. A terminal clip 73 may be used to attach a power source 74, 75 to the spouted bag terminals and or a charging stand as described in FIG. 21, 22.

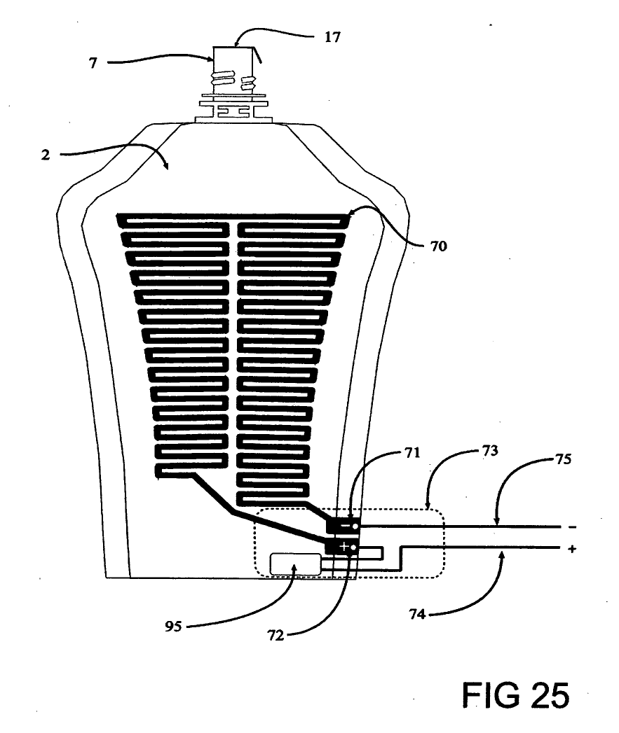

FIG. 25 shows a front view of a spouted bag 2 and demonstrates a further example of a flexible resistor 70. A thermal protector switch 95 or thermocouple 76 may be included integrally within the terminal charging clip 73 thus allowing the thermal protector switch or thermocouple to directly contact with the spouted bag 2 surface measuring the fluids 1 temperature and breaking or completing the circuit to heat the fluid 1 to a specified temperature.

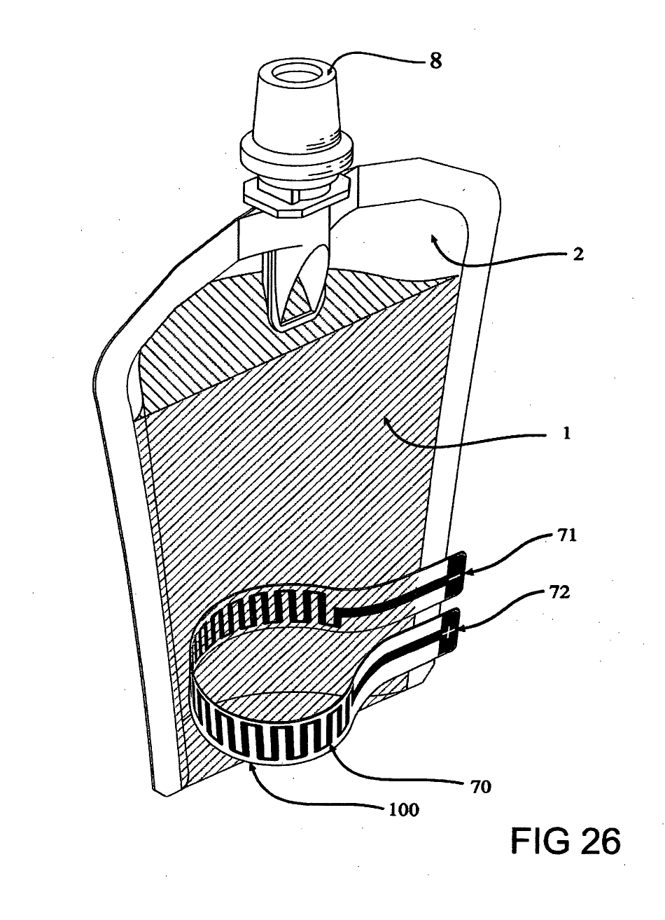

FIG. 26 is a semi cross sectional perspective view of disposable non-reusable spouted bag 2 and demonstrates a further example configuration for a flexible resistor 70. The flexible resistor 70 is shown to be bonded to or encased in a flexible non-conducting strip 100 which may be looped and contained within the spouted bag 2 with the positive 72 and negative 71 terminals exposed and protruding from the internal to the external of the bag 2 to which they are bonded. It may prove advantageous to immerse the flexible resistor 70 within the fluid 1 as shown as this allows the heat from the resistor 70 to pass directly into the fluid 1 and the feeder may touch the outer casing of the bag 2 and judge the fluid 1 temperature without touching the actual resistor 70 which could cause an incorrect judgement of the actual fluid 1 temperature. A terminal clip 73 may be used to attach a power source to the exposed spouted bag terminals 71, 72 and or a charging stand as described in FIG. 21, FIG. 22.

FIG. 27 is a semi cross sectional perspective view of disposable non-reusable spouted bag 2 and demonstrates a further example configuration for a flexible resistor 70. The flexible resistor 70 is shown to be attached to or bonded with or etched from the underside bag foil 101 with the positive 72 and negative 71 terminals exposed and protruding from the bag 2 to which they are bonded. A terminal clip 73 may be used to attach a power source to the exposed spouted bag 2 terminals 71, 72 and or a charging stand as described in FIG. 21, FIG. 22.

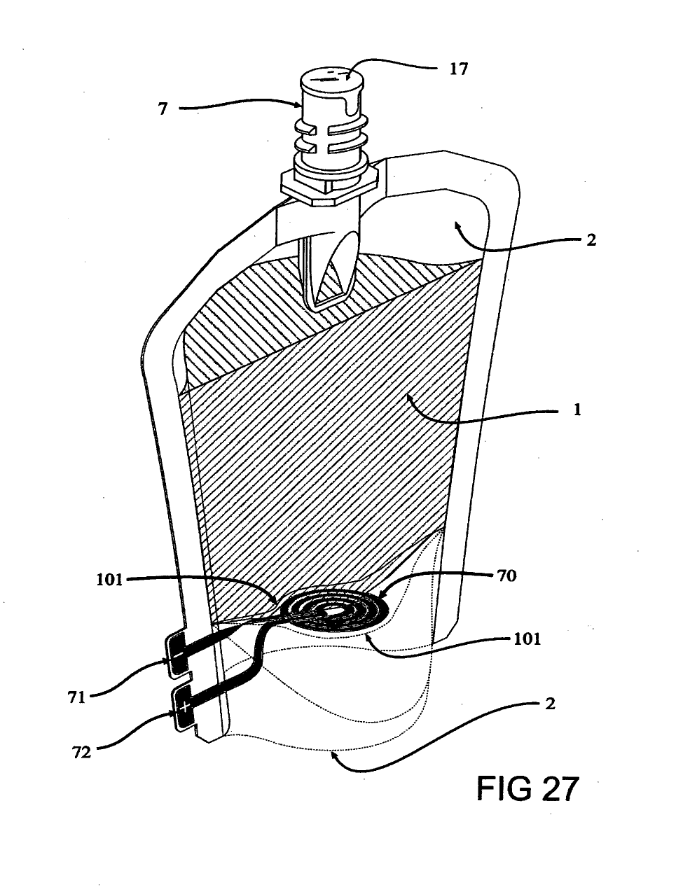

FIG. 28 is a semi cross sectional perspective view of disposable non-reusable spouted bag 2 and demonstrates a further example configuration for a flexible resistor 70. The flexible resistor 70 is shown to be attached to or bonded with or etched from the underside bag foil 101 with the positive 72 and negative 71 terminals exposed on the external surface of the underside bag foil 101. The terminals 71, 72 are located as to provide a large surface area for contacting with the terminals on a charging stand 90 or an external power source to the exposed spouted bag terminals 71, 72.

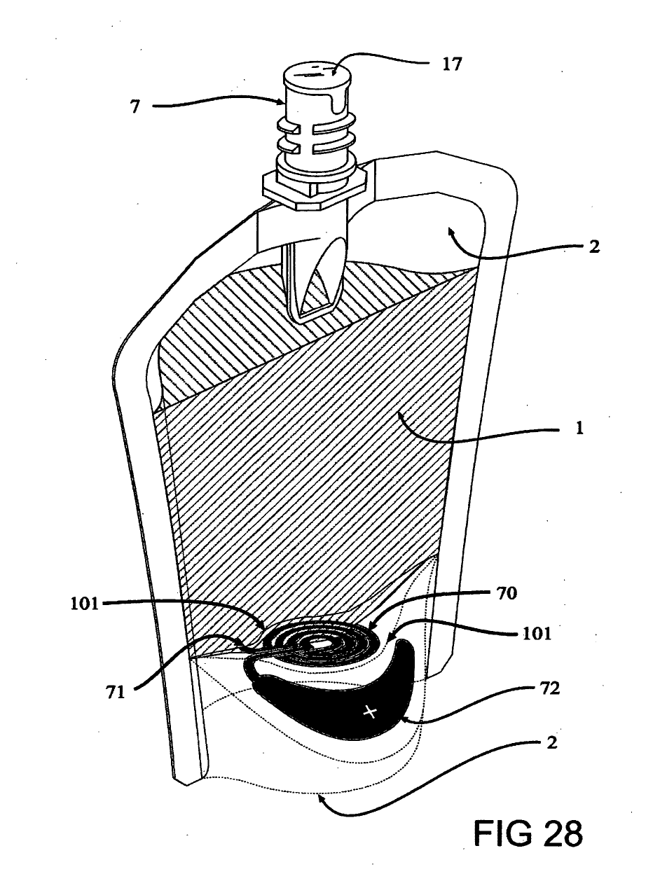

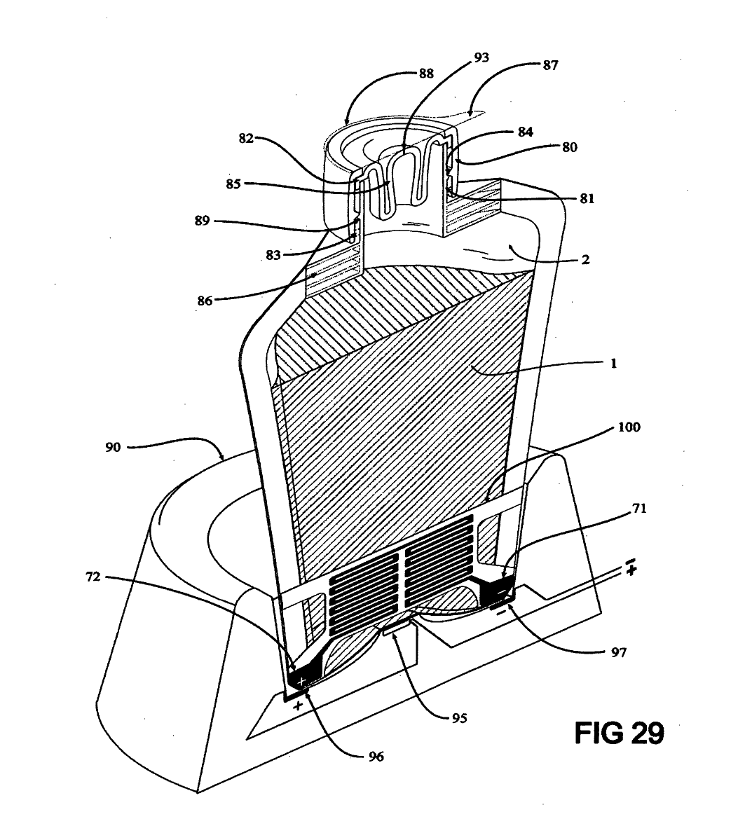

FIG. 29 is a cross sectional perspective view of a charging stand 90 containing a disposable non-reusable spouted bag 2. The flexible resistor 70 is shown to be bonded to or encased in a flexible non-conducting strip 100 which may stretch and or pass from one wall of the bag 2 to the opposing wall being contained within the spouted bag 2 with the positive 72 and negative 71 terminals exposed on the outer surface of the bag 2 and or protruding from the internal to the external of the bag 2 to which they may be bonded.

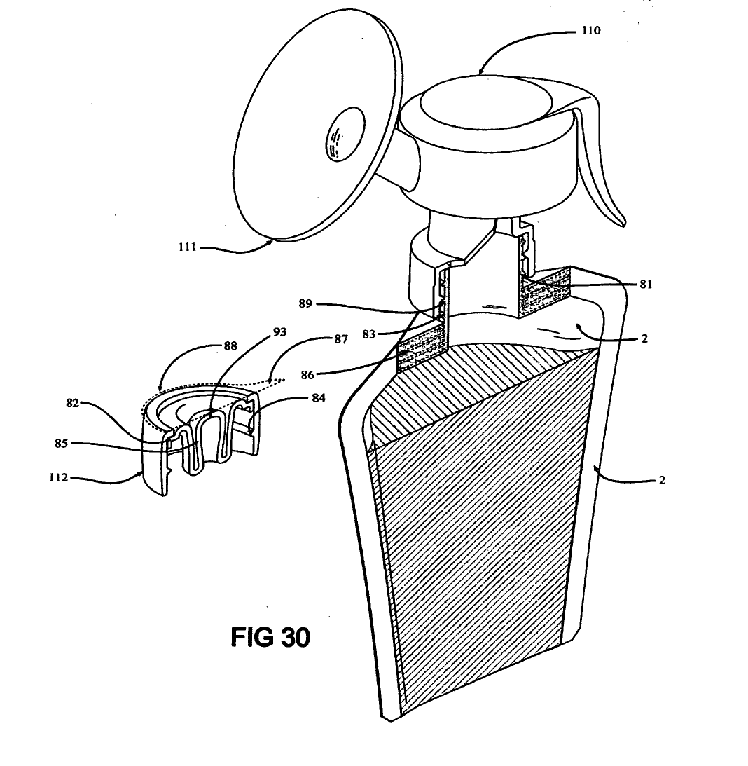

FIG. 30 is a semi cross sectional perspective view of disposable non-reusable spouted bag 2. The spouted bag may have a removable lid 112 with teat 85 allowing the bag 2 to be directly attached to a breast pump 110. The non-reusable spouted bag 2 may thus remain sterile and empty until the lid 112 is removed and it attached and filled with natural breast milk through utilising the breast pump 110. The Breast pump 110 may be electrical and or manually operated and will suck milk from the mother's breast and fill the non-reusable spouted bag 2

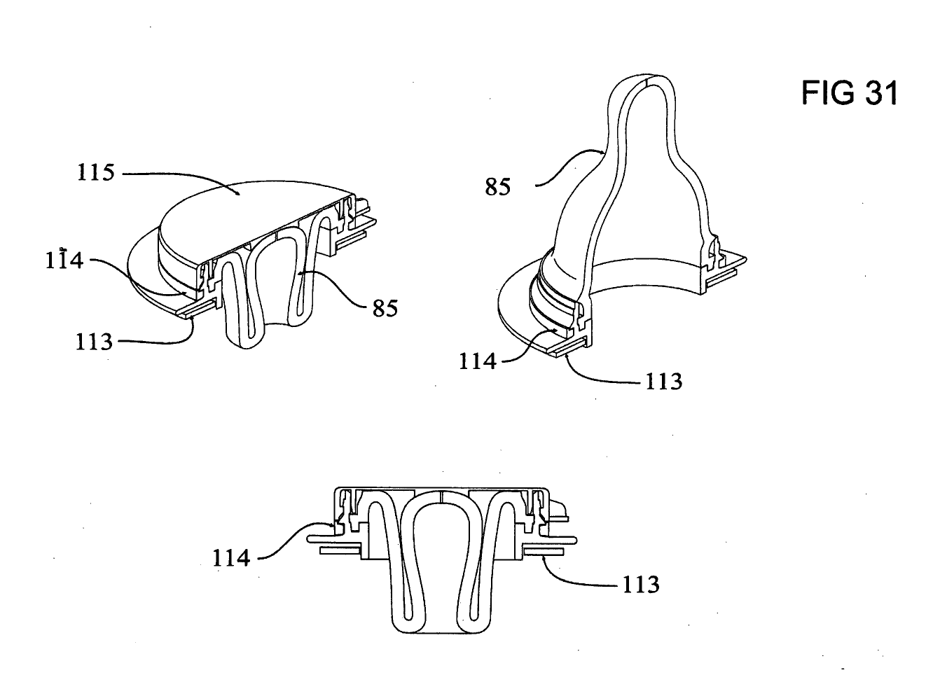

FIG. 31 shows three cross sectional views of a pouch or bag or sachet 2 closure with a compressible teat 85. The teat 85 may be co-injected and or formed within the same mould as the spout or closure. Two of the drawings show a teat 85 to be contained within the closure and or spout and a pull off lid or cap 115 is shown to be sealing and containing the teat 85. The pull off lid or cap 115 may be attached to the ring 113 by means of a frangible seam and or connection points. A further drawing shows the teat 85 to be fully extended from the spout or closure with the cap or lid 115 removed.

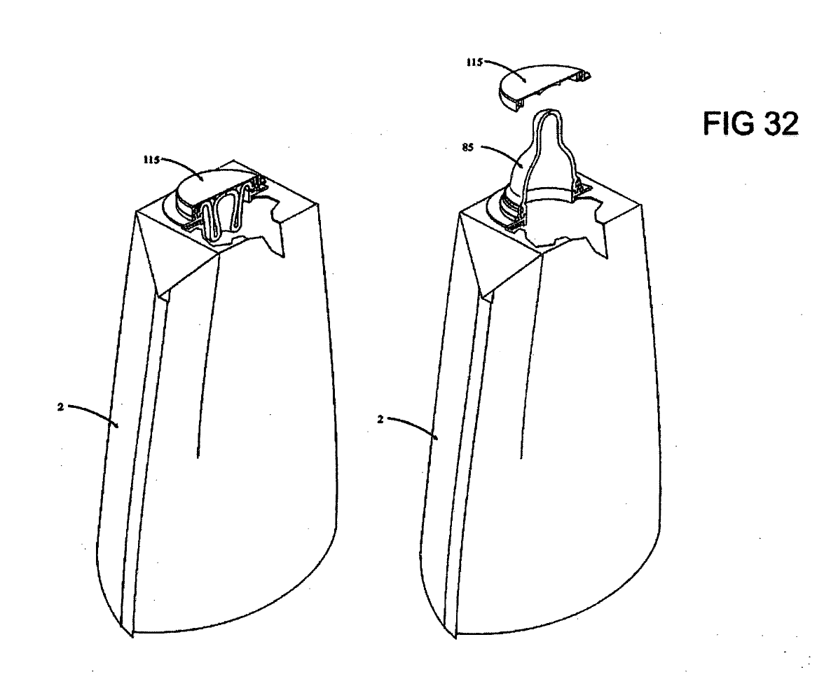

FIG. 32 shows two semi cross sectional perspective views of a pouch and or bag 2 with compressible teat closure. One of the drawings shows a teat 85 to be contained within the closure and or spout and a pull off lid or cap 115 is shown to be sealing and containing the teat 85. A further drawing shows the teat 85 to be fully extended from the spout or closure with the cap or lid 115 removed.

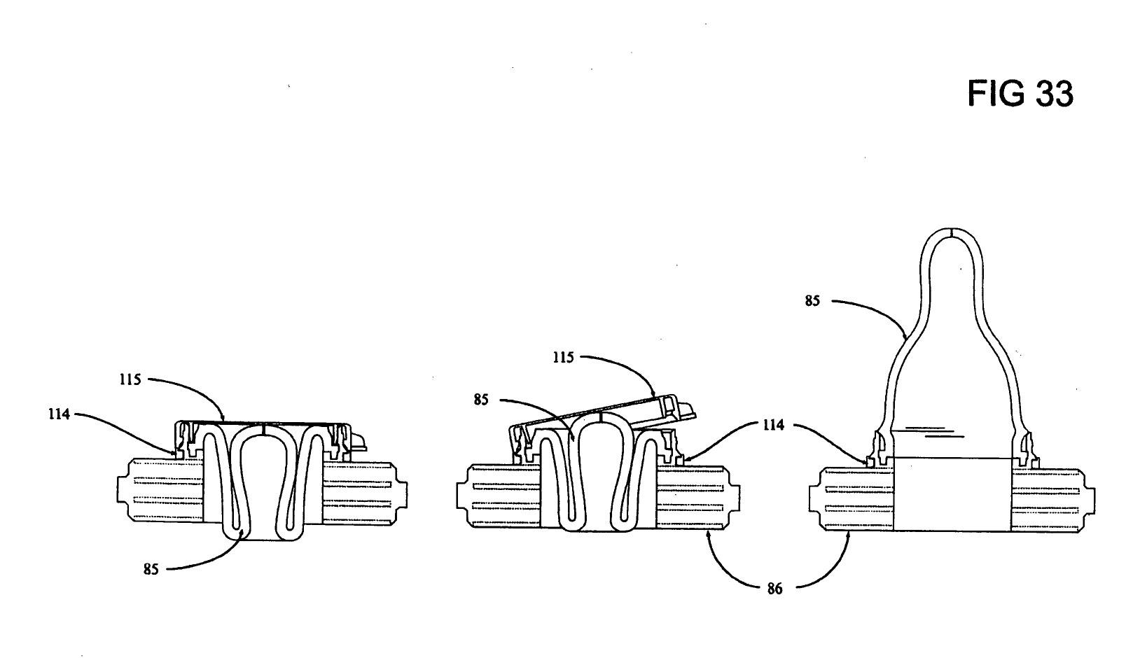

FIG. 33 shows three cross sectional views of a pouch or bag 2 or sachet closure or spout with a compressible teat 85. Two of the drawings show a teat 85 to be contained within the closure and or spout and a pull off lid or cap 115 is shown to be sealing and containing the teat 85. The pull off lid or cap 115 may be attached to the ring 113 by means of a frangible seam and or connection points. A further drawing shows the teat 85 to be fully extended from the spout and or closure with the cap or lid 115 removed.

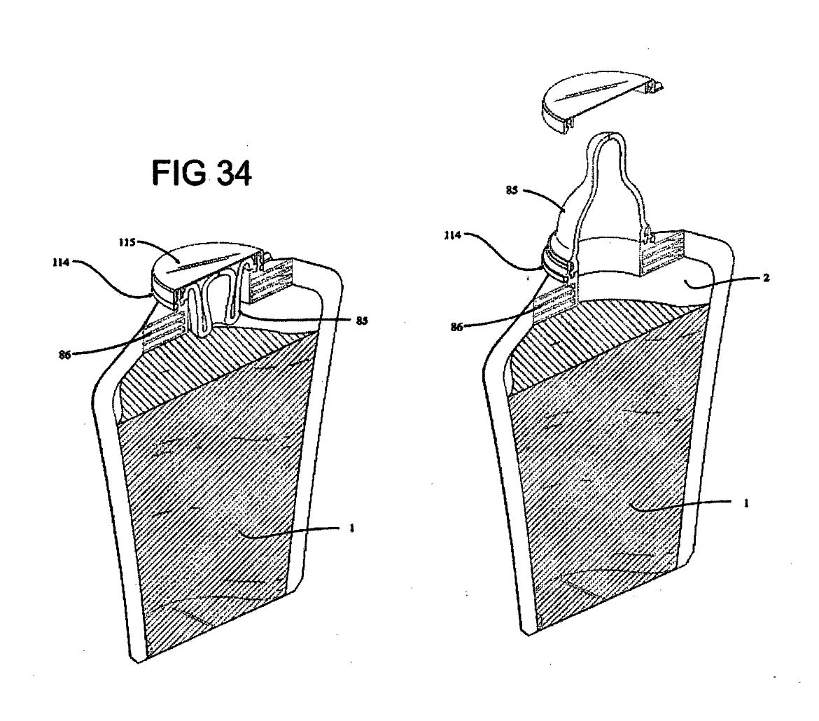

FIG. 34 shows two cross sectional perspective views of a pouch or bag 2 with compressible teat 85. One of the drawings shows a teat 85 to be contained within the closure and or spout and a pull off lid or cap 115 is shown to be sealing and containing the teat 85. A further drawing shows the teat 85 to be fully extended from the spout or closure with the cap or lid 115 removed.

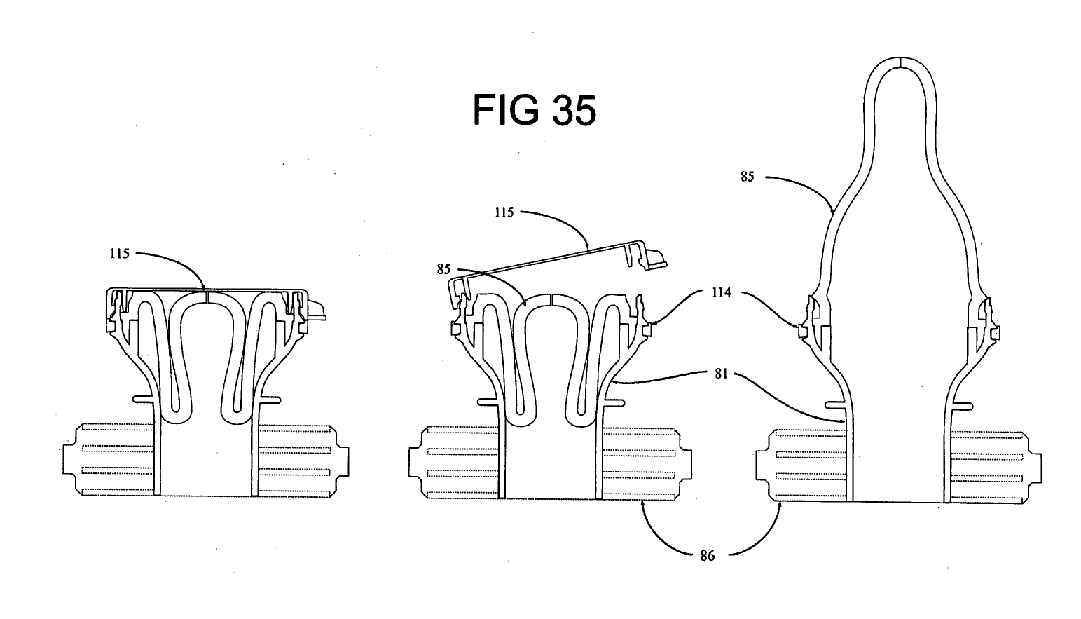

FIG. 35 shows three cross sectional views of a sachet closure or spout with a compressible teat 85. Two of the drawings show a teat 85 to be contained within the spout 81 and a pull off lid or cap 115 is shown to be sealing and containing the teat 85. A further drawing shows the teat 85 to be fully extended from the spout or closure with the cap or lid 115 removed.

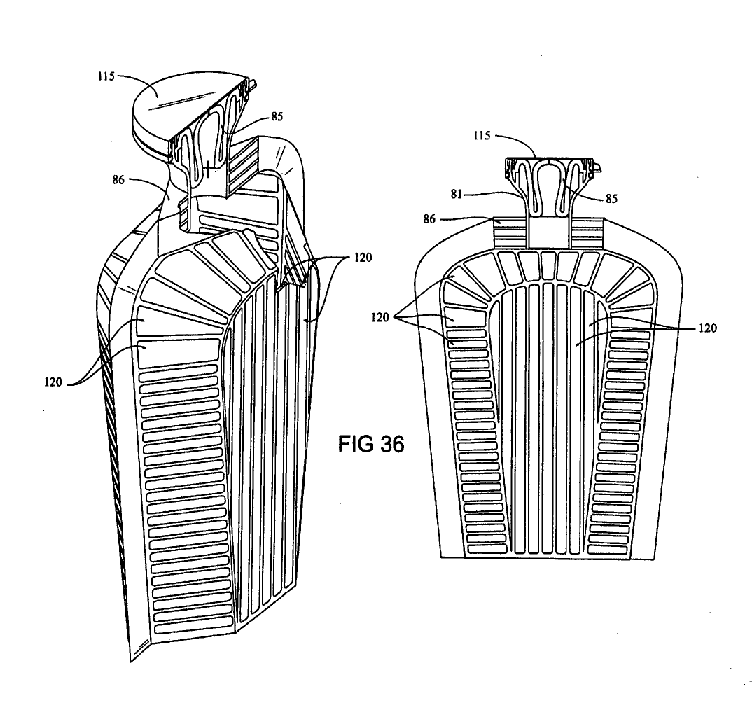

FIG. 36 shows one semi cross sectional perspective view and one semi cross sectional front elevation of a pouch or bag 2 with compressible teat closure 85. The pouch is shown to incorporate pressurised gas pockets 120 which are formed between the laminates and or layers from which the bag 2 is constructed. These gas pockets 120 may be positioned as to provide the bag 2 with a more defined structure and or shape through defining the position and shape the pressurised gas pockets 120 as force the bag 2 to take on the desired form due the to pressurised gas pockets 2 forming a semi ridged area whilst the laminates and or non pressurised foil between the gas pockets remains flexible. The gas pockets 120 may be formed through bonding the laminates and or foils together around the immediate area of the gas pocket within a high atmospheric pressure environment whilst allowing the laminates and or foil to remain un-bonded within the areas in which the gas pockets 120 are required. The gas pockets 120 subsequently inflate and become semi ridged when the bag 2 and or laminate is introduced into a lower pressure normal environment and thus create a more defined semi ridged bag and or pouch or other item constructed from said laminate and or foil with no added materials and or components.

FIG. 37 is a semi cross sectional perspective view of a pouch or bag 2 or sachet for feeding colostrum and or milk and or medicine to a nursing animal. The pouch or bag 2 or sachet may be pre filled and or aseptic with a hole 126 forming a handle which may utilise a pressurised gas pocket 120 to be created in a pocket thus allowing the handle to be semi ridged.

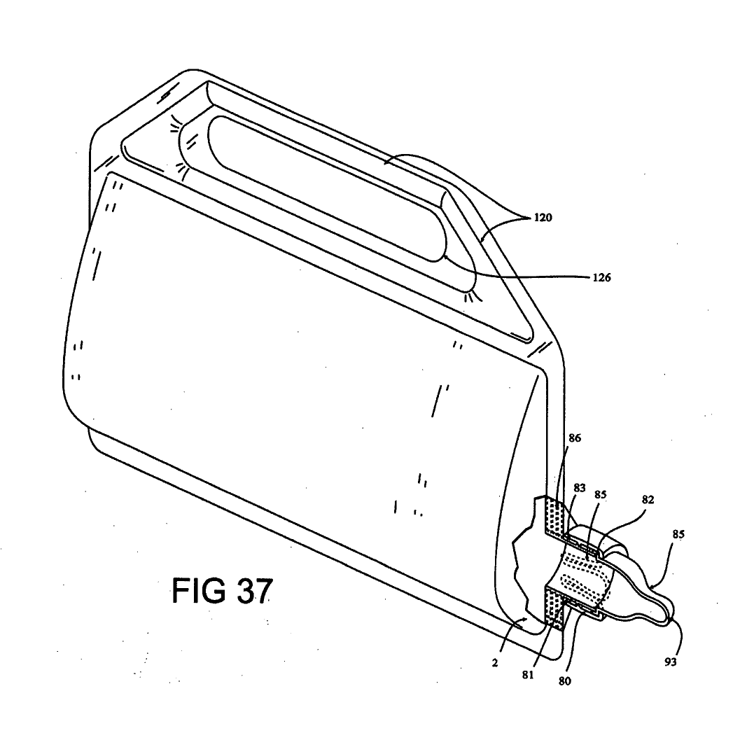

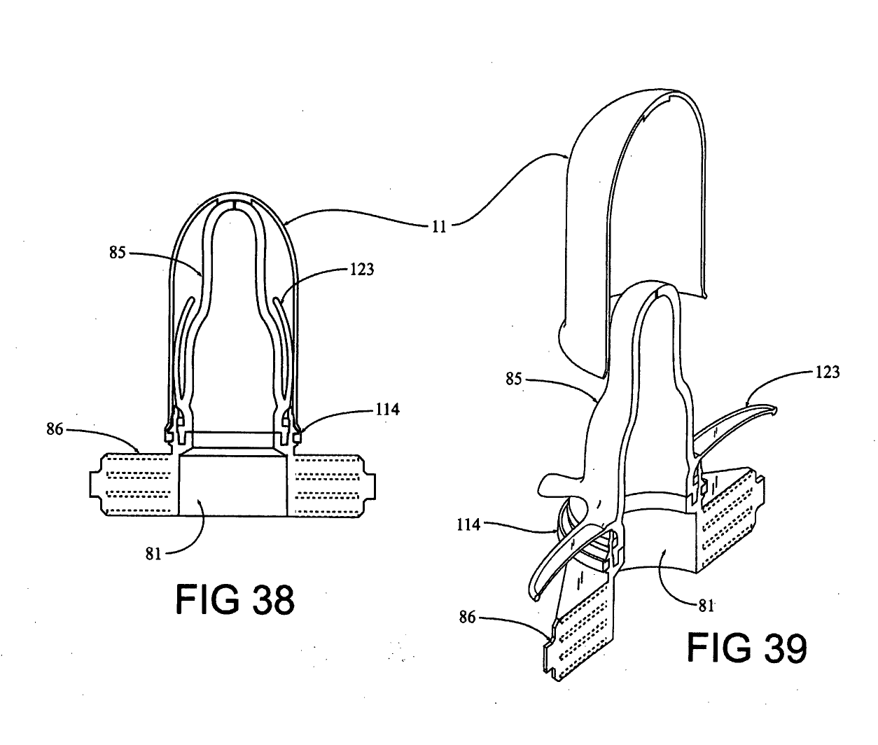

FIG. 38 shows a cross sectional view of a co-injected teat 85 and closure and or spout 81 which said teat 85 includes flexible mouth guards 123 which may be stored held within the teat cap 11 and upon the teat cap 11 being removed they may naturally fold out due to the memory within the flexible and or elastic material from which they are formed as to be provide a guard for the baby and or infants mouth whilst feeding, thus ensuring that any hard and or sharp surfaces upon the spout 81 base 86 and or bag 2 do not hurt the feeding baby.

FIG. 39 shows a cross sectional perspective view of a co-injected teat 85 as described in FIG. 38 with the teat cap 11 removed and the flexible mouth guards 123 folded out into an open position.

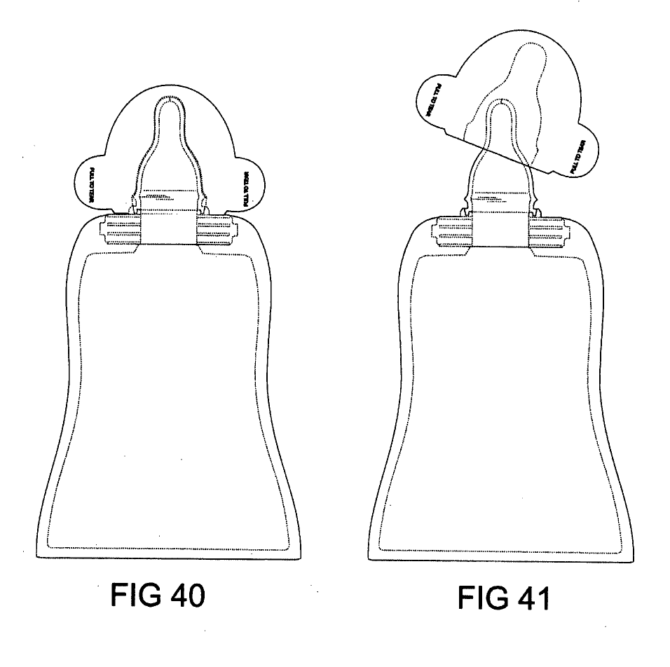

FIG. 40 shows a pre-filled disposable non-reusable bag 2 and or pouch or sachet which has an eye shaped base or boat 86 being heat-sealed into the bag 2 which said bag 2 extends upwardly as to entirely cover and seal said base 86 and spout and or teat 85 within the upper portion of the bag 2. Thus the bag 2 and or sachet forms a cap and or closure 127 which may include a perforation or frangible seam 124 allowing the top part of the bag 2 to be removed thus exposing the spout and or teat 85.

FIG. 41 shows a pre-filled disposable non-reusable bag 2 and or pouch or sachet as described in FIG. 41 which has the cap and or closure 127 removed .

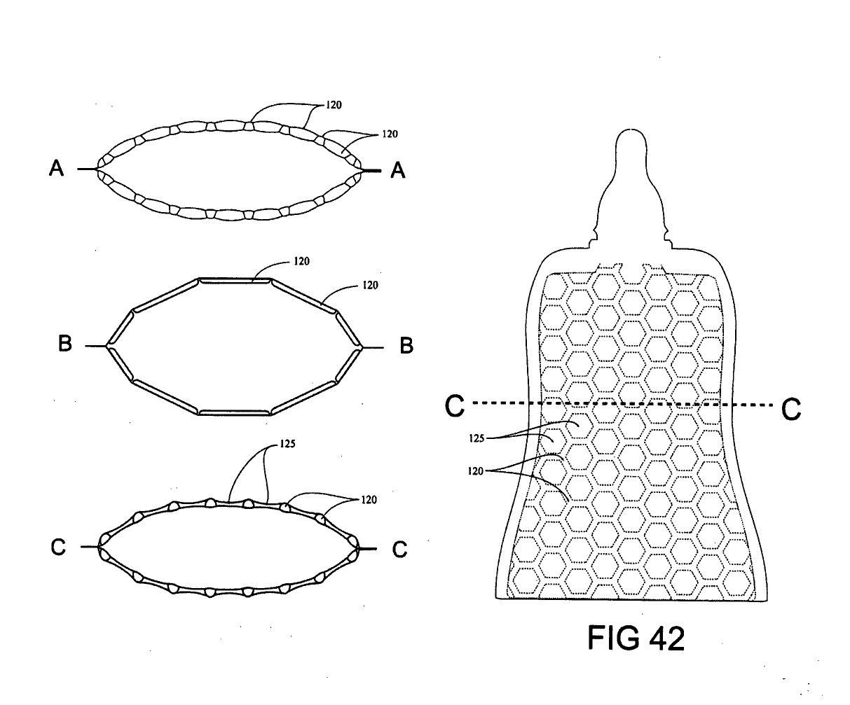

FIG. 42 shows a semi frontal plan view of a bag 2 and or pouch or sachet. The pouch or bag 2 is shown to incorporate a further example of pressurised gas pockets 120 which may be formed as to create a mesh and or pattern which in turn creates isolated spaces between the pressurised gas pockets 120. A further laminate and or foil or film may be bonded to the pressurised gas pockets 120 and the said laminate may be applied within a low pressure and or vacuum environment thus when creating a partial vacuum and or a low pressure gas pocket 125 isolated between the pressurised gas pockets 120. This provides a further method of controlling the bag 2 shape and form whilst creating a bag 2 and or foil or laminate which has the ability to semi insulate the contents of the bag 2 or pouch etc. Section C-C shows an example cross sectional view through the said bag 2. Whilst section B-B shows a further example cross section of a bag 2 which may contain only pressurised gas pockets 120. And section A-A shows a further example cross section of a bag 2 which may contain only pressurised gas pockets 120. The gas pockets 120, 125 may also be purposely calibrated as to become ridged and or change form and shape when the bag 2 and or bag contents is warmed due to the expansion of the air and or gas within the pockets when warmed.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

1-108. (canceled)

109. An infant feeding system comprising a sterile sealed laminated bag having a predetermined quantity of liquid infant food sealed therein, a compressed integral sterile teat sealed with the bag closure and or spout and a protective cap for the teat, the system being arranged such that the cap can be removed to enable the infant to feed from the sterile teat and food.

110. A disposable single use combined spout and teat closure being formed for bonding or heat sealing to the mouth of a pouch and or sachet wherein said teat is capped and or sealed into a compressed position and contained within the closure spout.

111. A disposable single use combined spout and teat closure being formed for bonding or heat sealing to the mouth of a pouch and or sachet wherein said teat is erect and upright extending from the spout and contained within tamper evident lid or dome.

112. A disposable single use spout and teat wherein said teat is compressed and contained within said spout with a frangible or removable cap or foil and will naturally unfold into an upright position due to the form of the teat and the potential energy stored within said teat under the compression of the cap or foil.

113. A disposable single use co-injection spout and teat wherein said teat is compressed and contained within said spout and said teat hole is sealed due to the pressure of the cap or foil upon said teat.

114. A disposable single use co-injection spout and teat wherein the upper portion of said spout is co-injected with the teat and then welded or bonded to the separate spout base to form a single unit.

115. A liquid pre-filled aseptic disposable non-reusable seamed sachet or pouch wherein the sachet or pouch is provided with a transparent window which may be covered with a sticker or film providing ultraviolet light protection for the sachet or pouch contents and being removable thus allowing the contents of the sachet or pouch to be visible.

116. A liquid pre-filled aseptic disposable non-reusable pouch or sachet for feeding liquid to a nursing baby or animal, comprising: laminate film and foil being heat-sealed to form a seamed bag with a plastic spout which generally has an eye shaped base being heatsealed into the mouth at the upper portion of the said bag and which said spout has attached and or contains an integral non-reusable teat which is bonded or attached to the said spout and said teat is compressed and or inverted and or sealed within the said spout with a foil, cap or closure and within or upon said bag a resistor is contained which is created and isolated from the foil, metal and or alloy from which the pouch or sachet is constructed by means of etching the resistors from the said bag foil and or surface and thus isolating and creating a flexible resistor which is able to generate heat when electricity is passed through it and thus warm or heat the food and or liquid contained within the said bag.

117. A liquid pre-filled aseptic disposable non-reusable pouch or sachet for feeding liquid to a nursing baby or animal, comprising: laminate film and foil being heat-sealed to form a seamed bag with a plastic spout which generally has an eye shaped base being heatsealed into the mouth at the upper portion of the said bag and which said spout is adapted to have a reusable teat threaded or snapped or attached to said spout and said reusable teat has the ability to pierce a foil which seals said spout upon contact or attachment to said spout and thus open the spout and allow the liquid contained within said bag to pass from the bag through said spout and out through said reusable teat.

118. A reusable feeding teat which is able to be connected and disconnected with a reusable teat plastic base through a thread or a push snap clipping system.

119. A reusable feeding teat being internally partitioned as to restrict the flow of liquid to a central channel of the partitioned teat.

120. A reusable pouch or sachet outer casing being formed specifically to accept and contain a non-reusable pouch or sachet wherein the non-reusable pouch or sachet is adapted to be placed into the outer casing and the spout pass through an opening from which it is able to protrude and said opening or underside form of said opening is such as to key the spout into position and stop the spout and bag from rotating whilst the teat and teat base are attached to said spout and tightened onto said outer casing.

121. A charging clip with an internal battery or external power source which is specifically designed to clip to the external surface of a pouch or sachet and contact the terminals on said clip to the terminals on the pouch or sachet with the intention of supplying an electrical current for the heating of the flexible resistor integral to the pouch or sachet.

122. A reusable handle which clips or threads or attaches to the outer surface and or spout area of a non-reusable pouch or sachet allowing the baby or consumer to easily grasp said handle, said handle incorporating guides and or arms which serve to stop the flexible pouch or sachet from flopping or moving about when the liquid is consumed from the bag.

123. A disposable non-reusable pouch or sachet comprising: laminate film and foil being heat-sealed to form a seamed bag or pouch with a plastic spout which generally has an eye shaped base being heat-sealed into the mouth at the upper portion of the said pouch and which said pouch extends upwardly as to covert and seal said spout within the top portion of the pouch which includes a perforation or frangible seam allowing the top part of the pouch to be removed thus exposing the spout.

124. A disposable single use combined teat and spout closure being formed with a boat shaped base for bonding or heat sealing to the mouth of a pouch and or sachet.

125. A disposable non-reusable pouch or sachet which comprises a combination of any of the described components and or items described within the drawings and or description and or claims.

126. A disposable non-reusable pouch or sachet which allows a breast pump to be attached to the spout of said pouch or sachet and thus allow the pouch or sachet to be filled with natural breast milk.

127. A liquid pre-filled aseptic disposable non-reusable sachet or pouch for feeding colostrum or milk to a nursing animal, comprising: laminate film and foil being heatsealed to form a seamed bag with a hole which allows a handle to be created in a pocket of pressurised gas or air thus allowing the handle to ridged and said pouch or sachet includes a plastic spout which generally has an eye shaped base being heat-sealed into the mouth at the upper portion of the said bag and which said spout has attached and or contains an integral non-reusable teat which is bonded or attached to the said spout and said teat is compressed and or inverted and or sealed within the said spout with a foil, cap or closure

128. A sachet or pouch which is constructed from multiple layers of film and or foil and said layers containing isolated pockets of air or gas.

129. An single use baby or animal feeding sachet or pouch with an integral teat which is constructed from multiple layers of film and or foil and said layers containing isolated pockets of pressurised air which are positioned and shaped as to provide rigidity shape and structure to the sachet or pouch.

130. A pre-filled disposable non-reusable bag and or pouch or sachet which includes a printed chemical thermometer upon the bags surface which may change colour and or numerical temperature readings as and when the bag or bag contents are warmed or cooled.
